(19) United States
(12) Patent Application Publication
(10) Pub. No.: US 2011/0127452 A1
(43) Pub. Date: Jun. 2, 2011

(54) Switching Valve and Method for Switching a Switching Valve

(76) Inventors: Heinz Kueck, Stuttgart (DE); Volker Mayer, Rechberghausen (DE); Karl-Peter Fritz, Boeblingen (DE)

(21) Appl. No.: 12/670,981

(22) PCT Filed: Jul. 15, 2008
(86) PCT No.: PCT/EP2008/005781

§ 371 Date: Jun. 9, 2010

(30) Foreign Application Priority Data
Jul. 27, 2007 (DE) 20 2007 010 743.9
Feb. 11, 2008 (DE) 10 2008 008 465.4

(51) Int. Cl. F16K 31/44

(52) U.S. Cl. 251/76

(57) ABSTRACT

A switching valve includes a fluid housing, at least one switching element within the fluid housing, and an actuator outside the fluid housing, wherein the actuator is configured to cause a pulse-like transmission of force on the switching element by means of an impact-like force effect on the fluid housing, so as to move the switching element from a first position to a second position, the switching element in the first position defining a first fluidic state of a fluid path through the fluid housing, and the switching element in the second position defining a second fluidic state of a fluid path through the fluid housing, which second fluidic state differs from the first fluidic state.

### CROSS-REFERENCE TO RELATED APPLICATIONS

This application is a national phase entry of PCT Patent Application No. PCT/EP2008/005781, filed 15 Jul. 2008, which claims priority to German Patent Application No. 202007010743.9, filed 27 Jul. 2007 and German Patent Application No. 102008008465.4 filed 11 Feb. 2008, each of which is incorporated herein by reference.

### BACKGROUND OF THE INVENTION

Embodiments of the present invention relate to a switching valve and to a method for switching a switching valve.

Switching valves may be used in many applications directed at switching on or off the flow of a fluid, or at switching from one flow path to another. This relates, for example, to applications in the field of automation technology, pneumatics, process technology, automobile technology, or medical technology. For applications employing toxic, aggressive or sensitive fluids, for example chemicals, fuels or body fluids, the service life of the switching valve may depend on a high sealing function of the fluid paths within the valve. Any contact between, e.g., electronic assemblies, resistors, coils, or bending converters and the fluid may cause problems which may shorten the service life of the valve. These problems may also exist in the field of biocompatibility. For example, electric assemblies may contain materials that are not biocompatible. However, for an application wherein body fluids, for example, are to be switched by the valve, it is very important that said body fluids only come into contact with biocompatible materials. For example, if the fluid can come into contact with non-biocompatible materials, this may lead to problems, in particular against the background of biocompatibility, within the context of a medical licensing procedure. Advantageously, the valve is configured such that that area of the valve which is filled with fluid or is contacted by the fluid has only such elements of the valve located therein which are insensitive toward the fluid.

With known valves, for example, a spring-loaded bolt is urged against a valve seat, it being possible for the bolt to be lifted off the valve seat by means of an electromagnet in order to open the valve.

Patent DE 3835788 A1 describes, for example, a fast-switching ball valve that comprises a ball which is seated in a valve seat and may be released from the valve seat by a lateral impact by means of an actuation device which acts in a direction transverse to the valve seat. The ball is returned to the valve seat by a flow which sets in following this and which carries along the ball and returns same to its valve seat. However, with DE 3835788 A1 it is not possible to control two equivalent fluidic states and to maintain same without any further energy consumption. Rather, DE 3835788 A1 is designed to effect fast switching between two fluidic states and to achieve this by means of short switching times and a high repetition rate. Thus, for DE 3835788 A1, a fluidic state, namely that of the closed valve, will usually be advantageous, and energy may be used for short-time opening of the valve.

From DE 19734845 C1, a fast-switching valve is known which contains a space comprising an inflow opening and an outflow opening, and a valve seat which is closable by a movable valve body, opens upon an actuation signal, and closes again. In this context, the valve seat, which is supported by an actuator, is moved away, upon the actuation signal, from the valve body faster than the valve body can follow. For this fast-switching valve, too, the state of the closed valve is advantageous, while the state of the open valve is adopted only for a short time while supplying energy by means of the actuator. If the actuator is located within the fluid chamber, wear and tear of the electronic components or electric lines of the actuator may still be reckoned with. If the actuator is located outside the fluid chamber, wear and tear of, e.g., the inflow opening and of the outflow opening, which are configured as flexible lines, may be reckoned with due to the abrupt movement of the valve seat in order to take advantage of the mass inertia of the valve body. In addition, DE 19734845 C1 is a self-closing valve which is closed again by the flow of fluid. If continuous flowing-through is to be realized, this may only be effected by permanently energizing the actuator, so as to achieve, e.g., an oscillating movement of the valve seat. Thus, the switching valve cannot adopt two or more defined switching positions.

According to an embodiment, a switching valve may have: a fluid housing; at least one switching element within the fluid housing, the switching element including a spherical object; an actuator outside the fluid housing, wherein the actuator is configured to cause a pulse-like transmission of force on the switching element by means of an impact-like force effect on the fluid housing, so as to move the switching element from a first position to a second position, the switching element in the first position defining a first fluidic state of a fluid path through the fluid housing, and the switching element in the second position defining a second fluidic state of a fluid path through the fluid housing, which second fluidic state differs from the first fluidic state; and at least one spring for holding the switching element inside the fluid housing, the at least one spring being configured to stably position the switching element in the first position or in the second position, and the spring being configured to receive an inflow of kinetic energy through the switching element for a change of the switching element from one of the two positions to the other of the two positions.

According to another embodiment, a method for switching a switching valve, which may have: a fluid housing; at least one switching element within the fluid housing, the switching element including a spherical object; an actuator outside the fluid housing; and at least one spring for holding the switching element inside the fluid housing, the at least one spring being configured to stably position the switching element in the first position or in the second position, and the spring being configured to receive an inflow of kinetic energy through the switching element for a change of the switching element from one of the two positions to the other of the two positions, may have the step of: applying an impact-like force effect on the fluid housing with the actuator so as to cause pulse-like force transmission to the switching element so as to move the switching element from a first position to a second position, the switching element in the first position defining a first fluidic state of a fluid path through the fluid housing, and the switching element in the second position defining a second fluidic state of a fluid path through the fluid housing, which second fluidic state differs from the first fluidic state.

Due to the design of the switching valve, wherein the switching element is mounted within the fluid housing and the actuation means is mounted outside the fluid housing, the switching valve may operate in a low-wear manner, since the actuation means, which may comprise, e.g., sensitive electronic or mechanical components, does not come into contact with the possibly aggressive fluid.

The switching valve comprises an actuation means configured to cause a pulse-like transmission of force on the switching element by means of an impact-like force effect on the fluid housing so as to move the switching element from a first position to a second position, the switching element in the first position defining a first fluidic state of a fluid path through the fluid housing, and the switching element in the second position defining a second fluidic state of a fluid path through the fluid housing, which second fluidic state differs from the first fluidic state.

A core idea of the invention consists in transmitting an impact-like force effect of the actuation means on the switching element by means of pulse transmission via the fluid housing wall so as to allow spatial separation of the switching element and the actuation means, so that the actuation means need not be protected against aggressive fluids. Separating the actuation function of the switching valve from the switching function of the switching valve allows particularly low-wear implementations of the switching valve.

Within the fluid housing, the switching element may adopt two equivalent positions, each of the two positions being characterized by a specific fluidic state. For example, the first position may correspond to an open valve, whereas the second position may correspond to a closed valve. An open valve may be described, for example, by a first fluidic state, whereas a closed valve may be described by a second fluidic state. Both the first and the second positions may be adopted by an impact-like force effect on the fluid housing by means of the actuation means. None of the two positions is an advantageous position, so that once a position has been adopted, it will be maintained by the valve for such time until the actuation means has more energy supplied to it so as to change the position of the switching element by a new impact on the fluid housing.

A fluidic switching state that has been adopted may be maintained without any further energy consumption. Energy supply may be used for switching between two fluidic switching states that are associated with two fluidic states, for example fluidic resistances. After a switching operation, energy supply may be interrupted or switched off until renewed switching is desired.

Due to the media separation of the switching element and the actuation means, the switching element being located within the fluid housing, and the actuation means being located outside the fluid housing, the switching valve may be configured to be insensitive to signs of wear and tear which may be caused by the fluid. Since the essential components of the drive may be accommodated within the actuation means, the actuation means being located outside the fluid housing, the electronic components of the actuation means do not come into contact with the fluid. Also, it is not required to use flexible, i.e. movable, supply tubing for coupling the fluid to the switching valve, since the switching valve does not need to move the fluid housing in order to switch the two fluidic states. Therefore, the fluid path through the fluid housing may be configured, for example, using low-wear, ideally no-wear, connector elements.

What is understood by an n/m-way valve is a valve having n inlets and outlets and a total of m switching states. The variants described below may be realized, among other things, as 2/2-way valves and 3/2-way valves, the fluidic switching element determining one of the two switching states in each case, and the converter element consuming no energy except during the time of the switching operation. It shall be assumed by way of example for all of the embodiments of the valves that a ball is employed as the fluidic switching element, and that the ball will adopt its position in position elements in a self-centering manner for both switching states.

Embodiments of the present invention will be detailed subsequently referring to the appended drawings, in which:

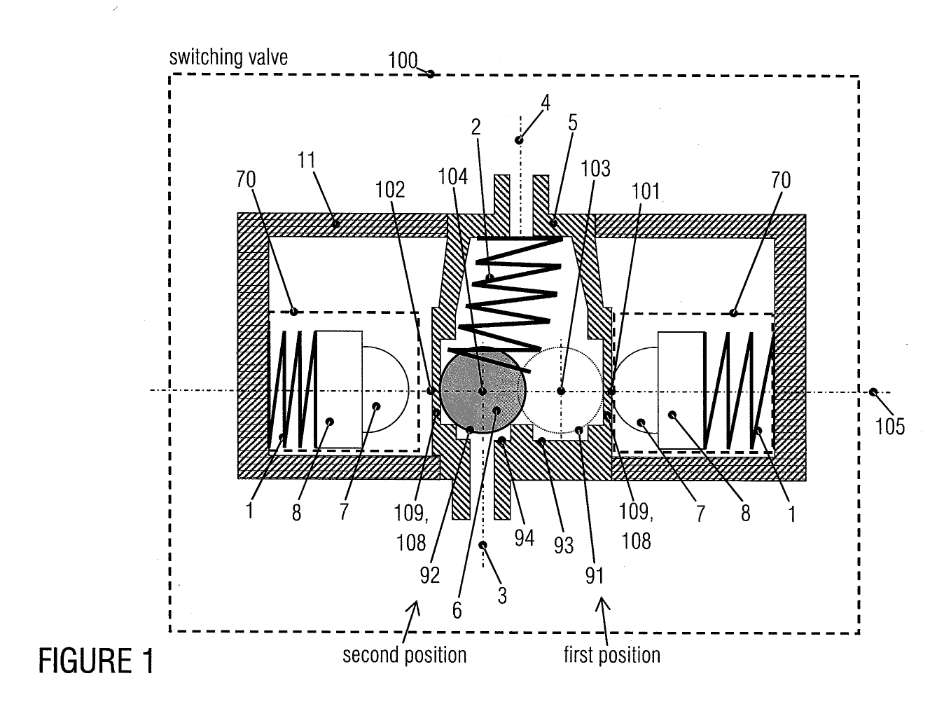

FIG. 1 shows a schematic longitudinal section through the switching valve in accordance with an embodiment;

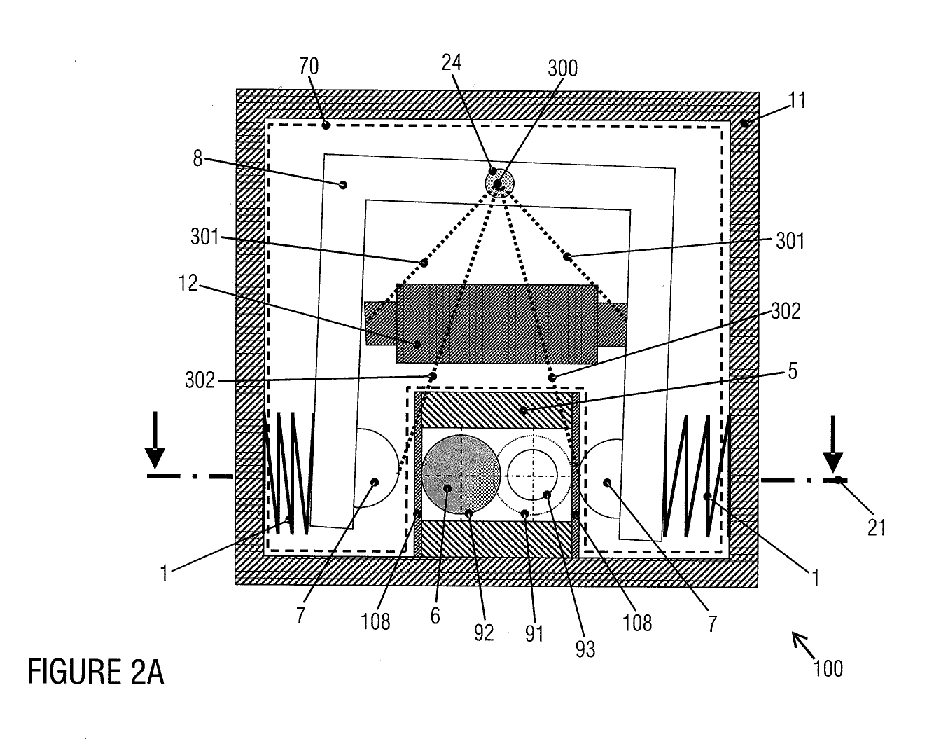

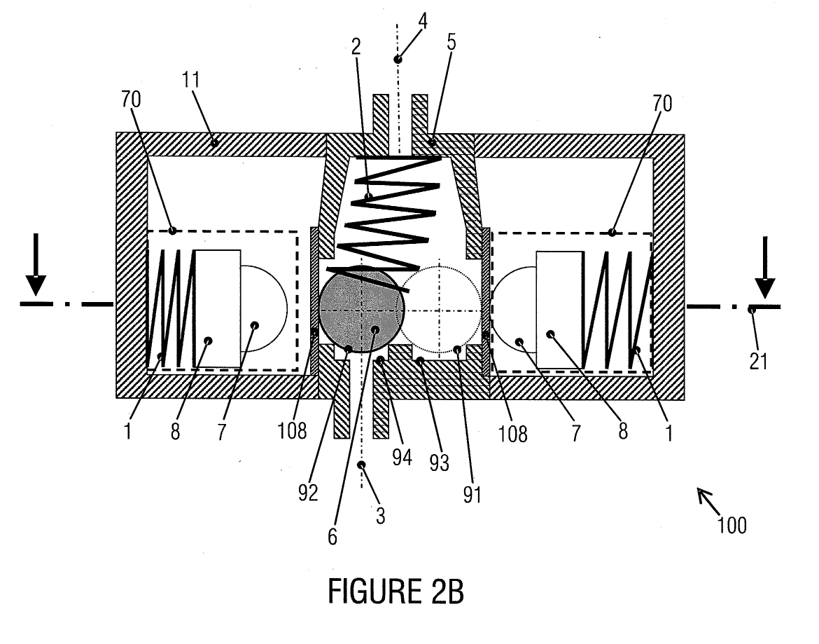

FIGS. 2a/b show a schematic cross-section/longitudinal section through the switching valve in accordance with a further embodiment;

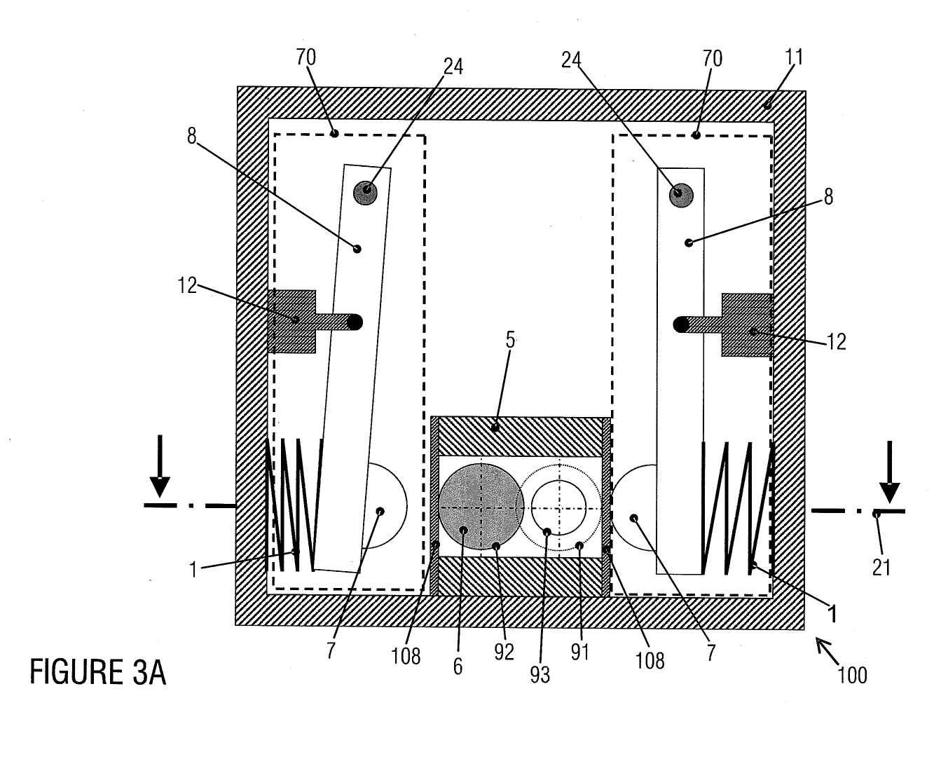

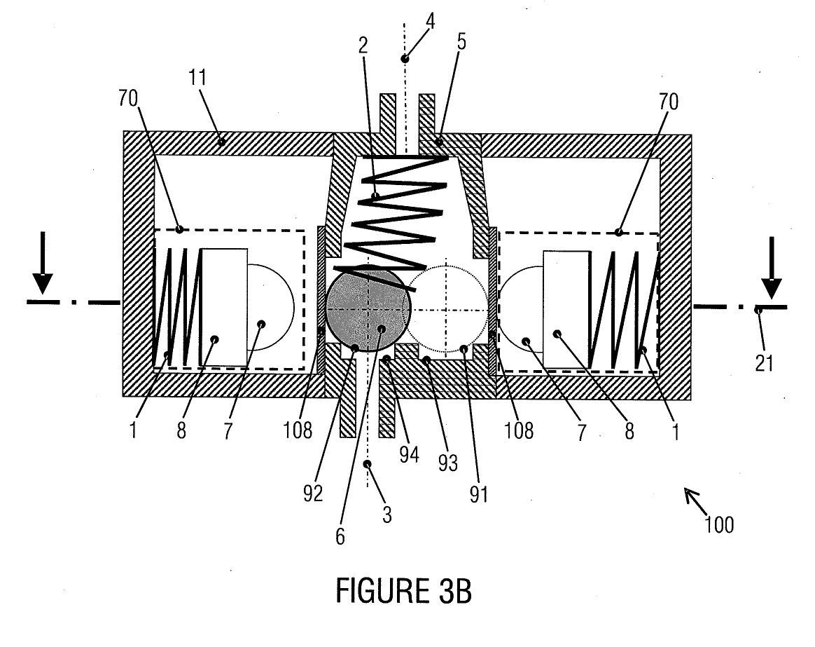

FIGS. 3a/b show a schematic cross-section/longitudinal section through the switching valve in accordance with a further embodiment;

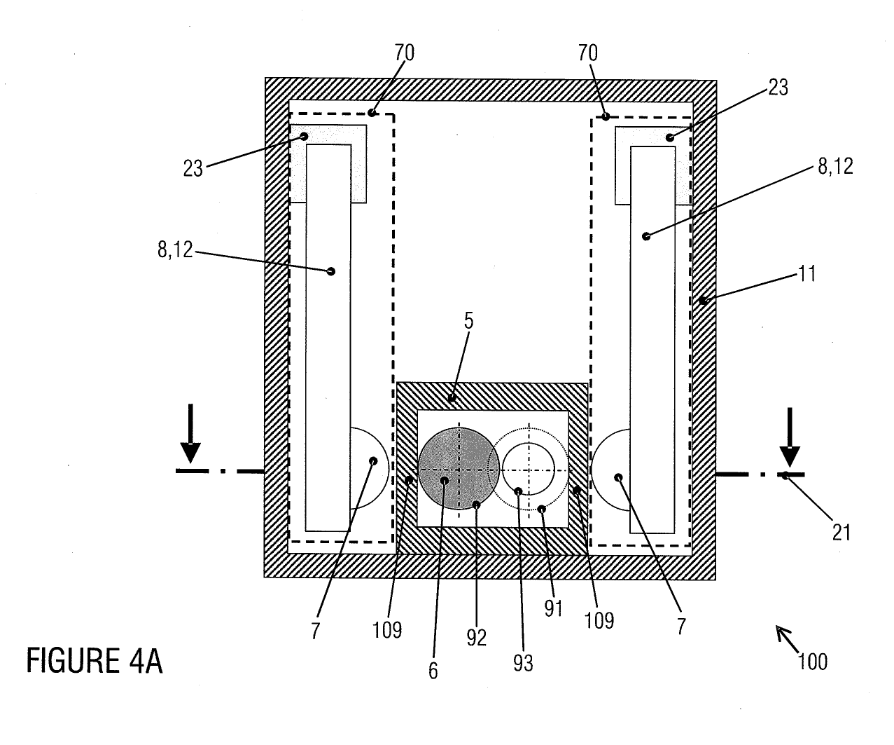

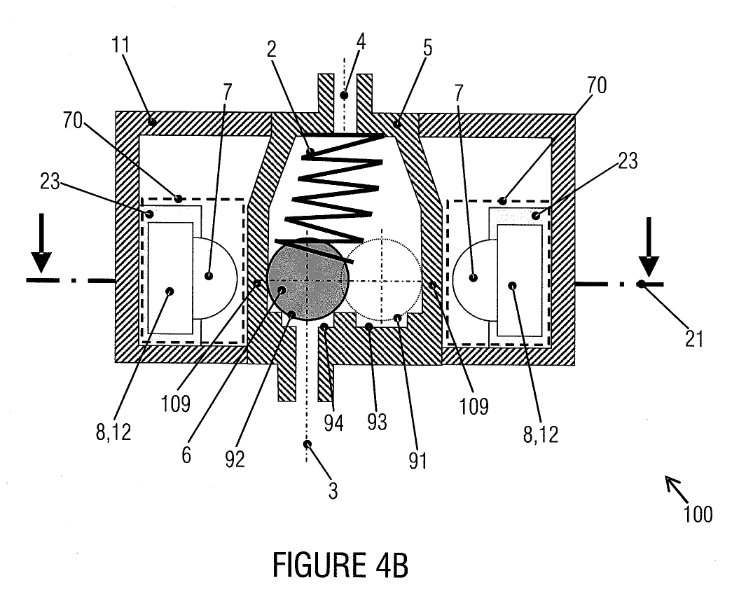

FIGS. 4a/b show a schematic cross-section/longitudinal section through the switching valve in accordance with a further embodiment;

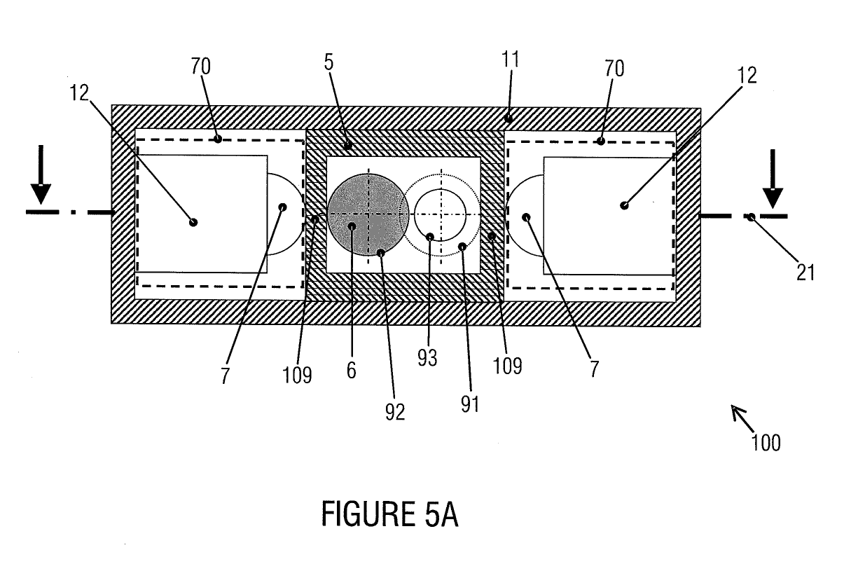

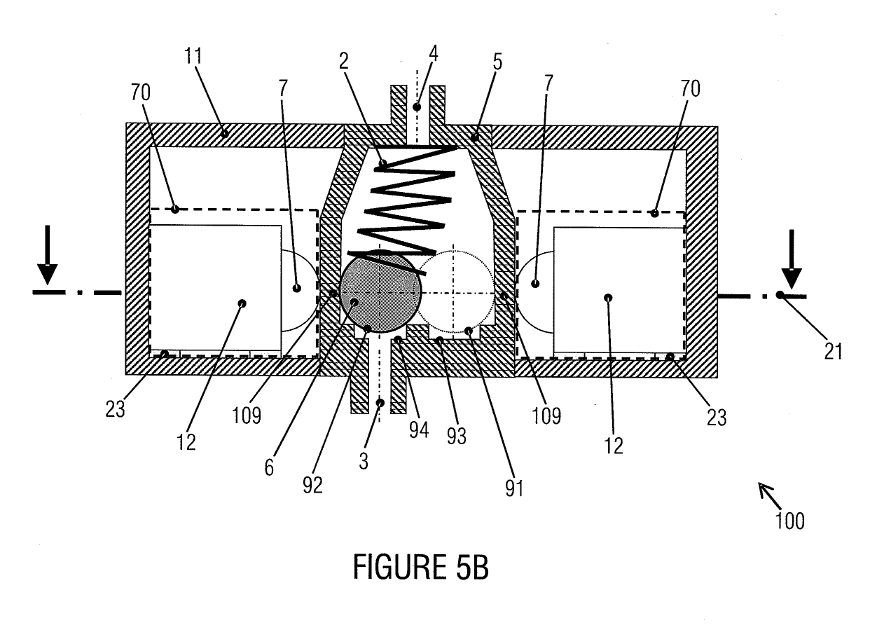

FIGS. 5a/b show a schematic cross-section/longitudinal section through the switching valve in accordance with a further embodiment;

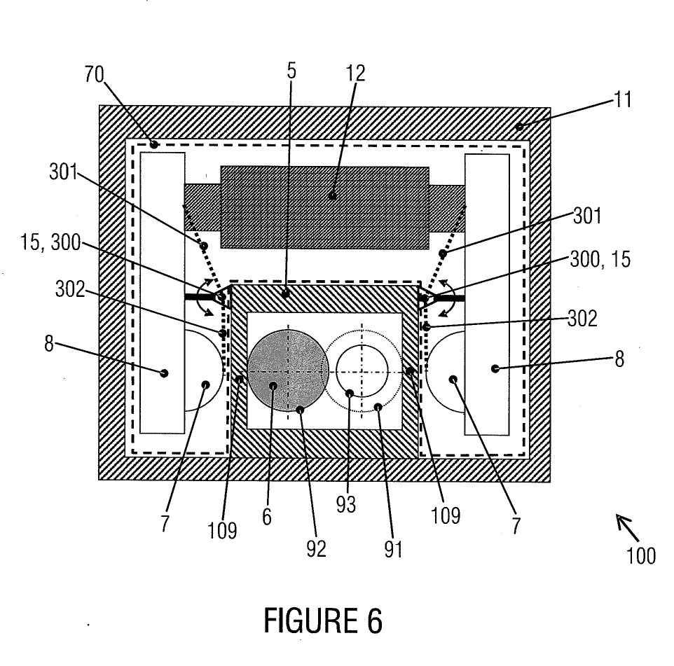

FIG. 6 shows a schematic cross-section through the switching valve in accordance with a further embodiment;

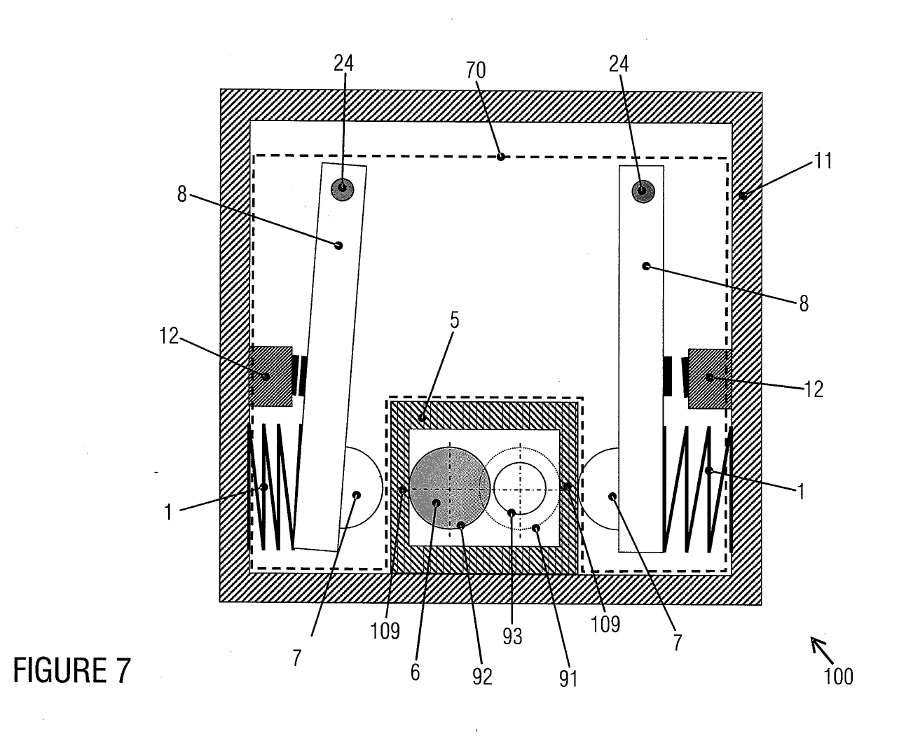

FIG. 7 shows a schematic cross-section through the switching valve in accordance with a further embodiment;

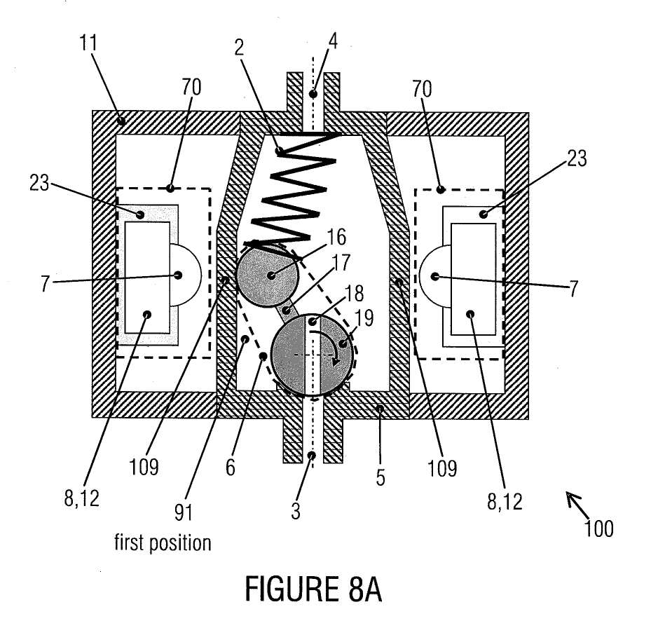

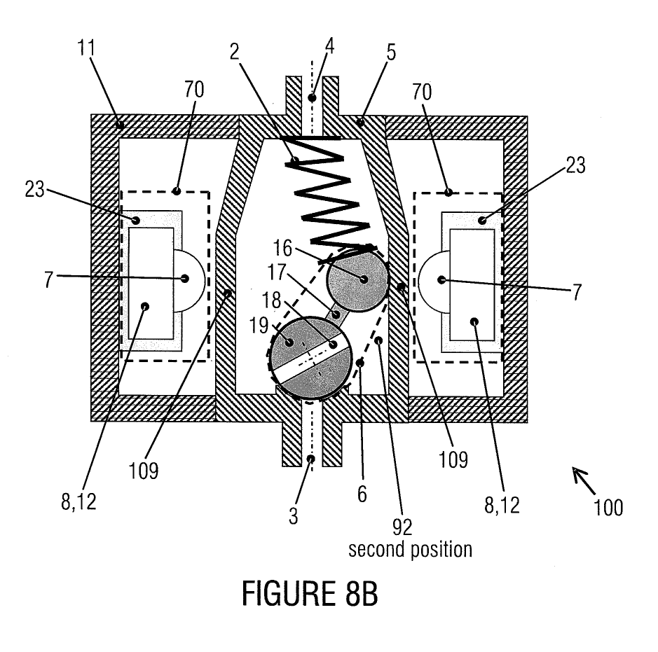

FIGS. 8a/b show schematic longitudinal sections through the switching valve in accordance with a further embodiment with the switching valve being in a first/second position;

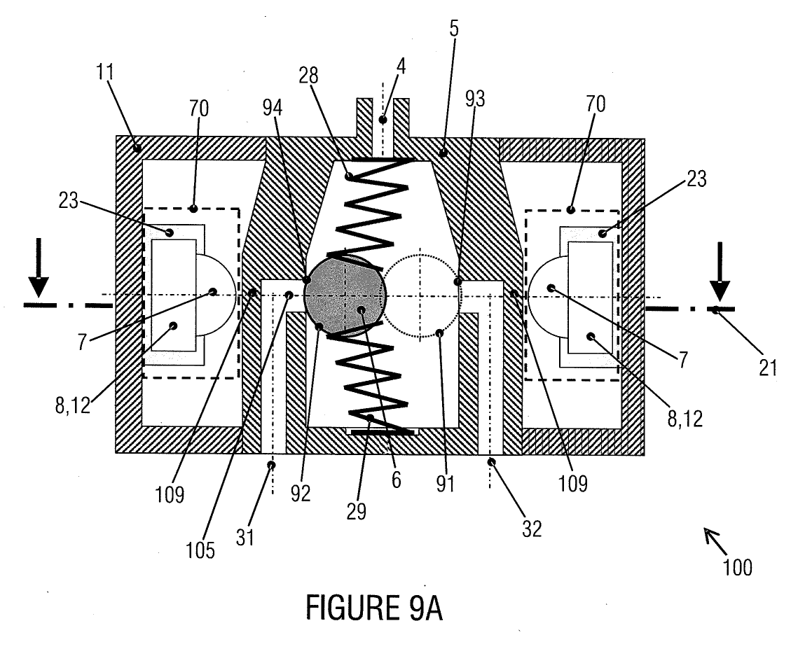

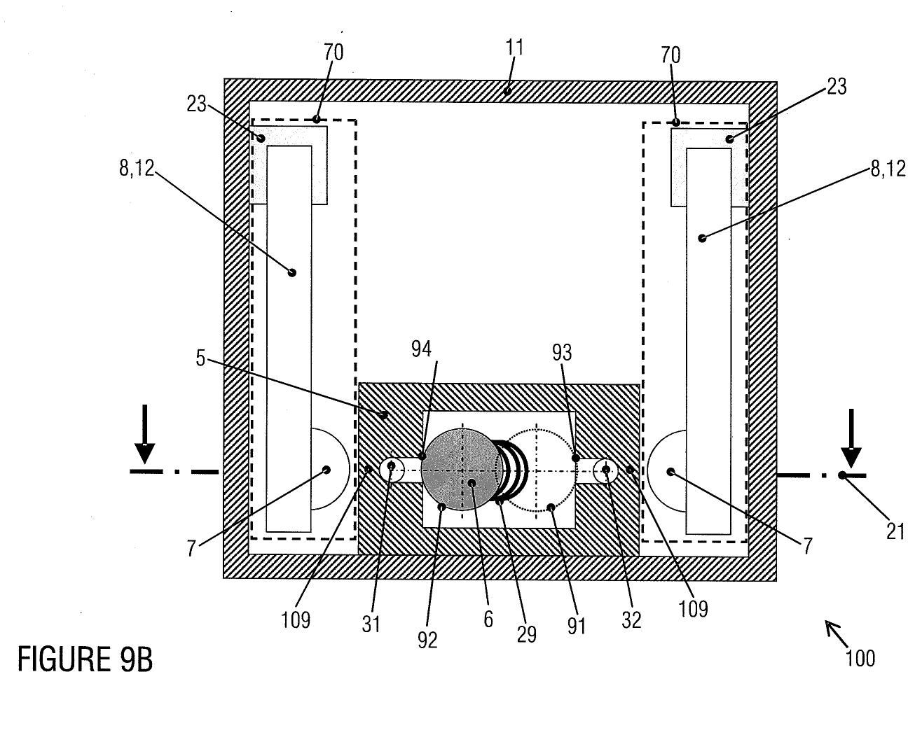

FIGS. 9a/b show a schematic longitudinal section/cross-section through the switching valve in accordance with a further embodiment;

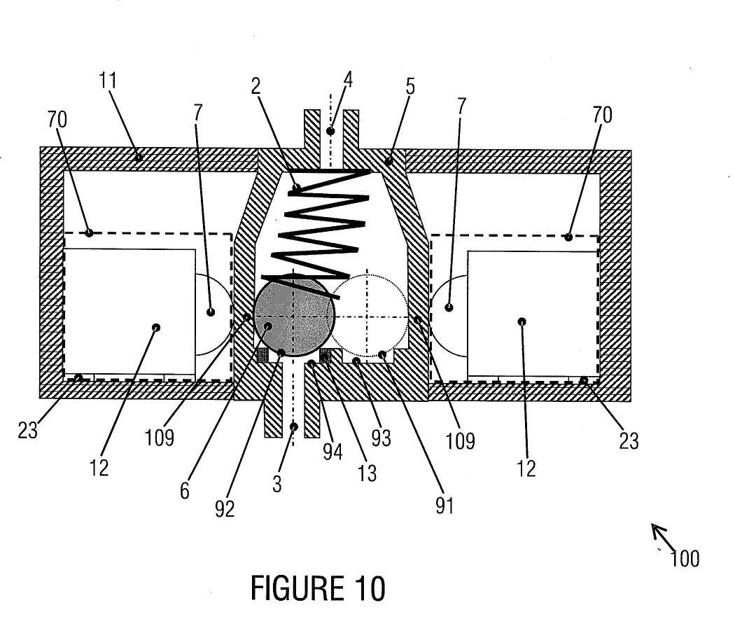

FIG. 10 shows a schematic longitudinal section through the switching valve in accordance with a further embodiment;

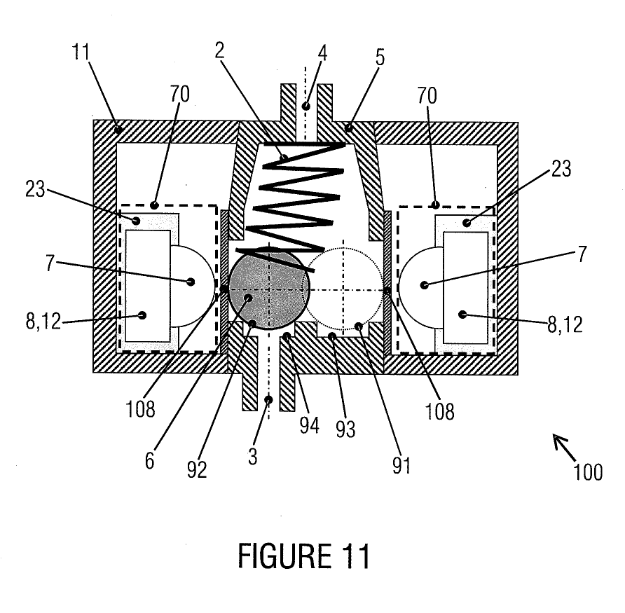

FIG. 11 shows a schematic longitudinal section through the switching valve in accordance with a further embodiment;

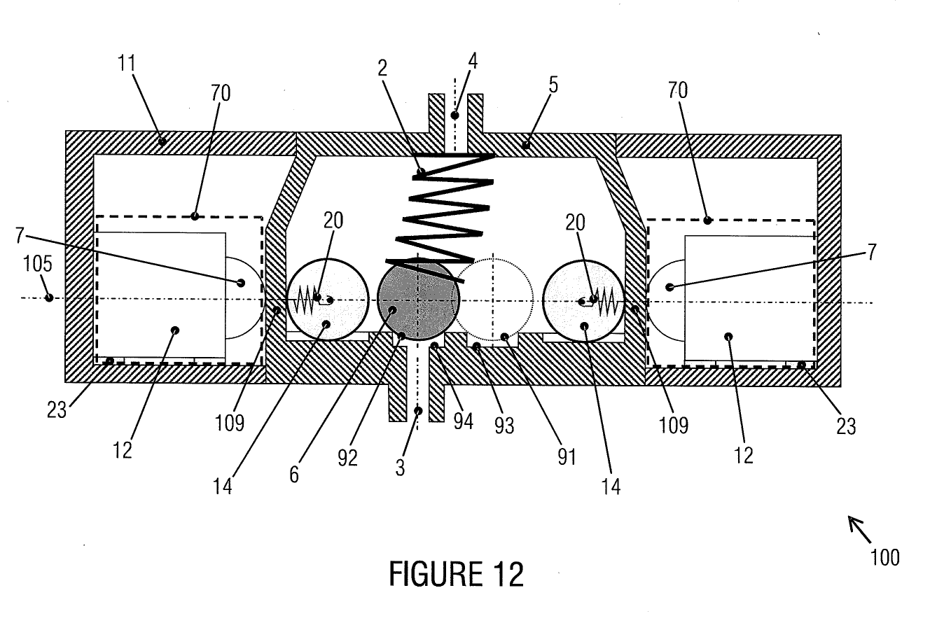

FIG. 12 shows a schematic longitudinal section through the switching valve in accordance with a further embodiment;

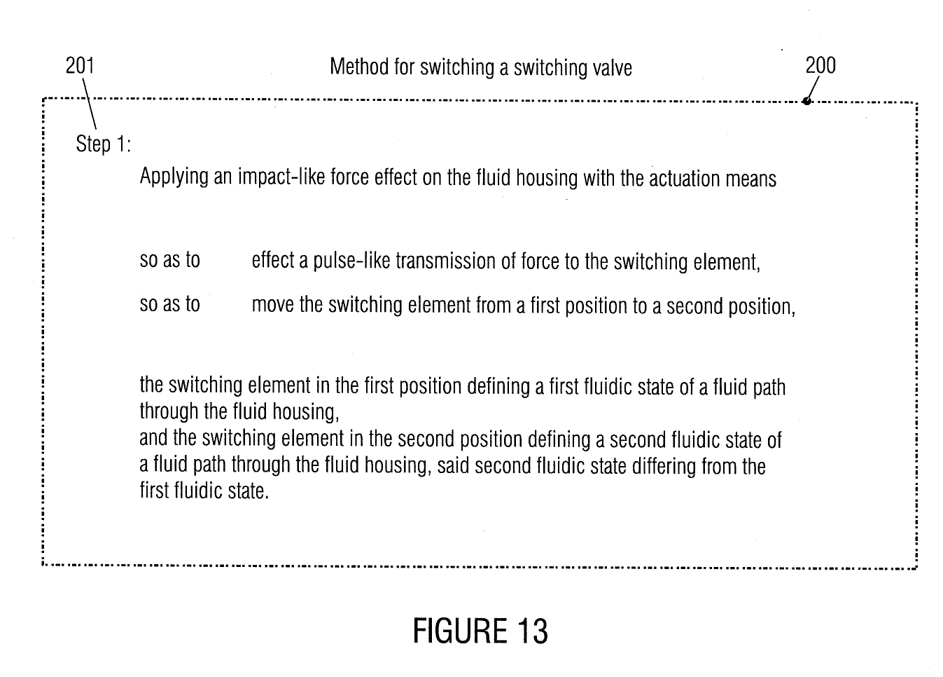

FIG. 13 shows a representation of a method for switching a switching valve; and

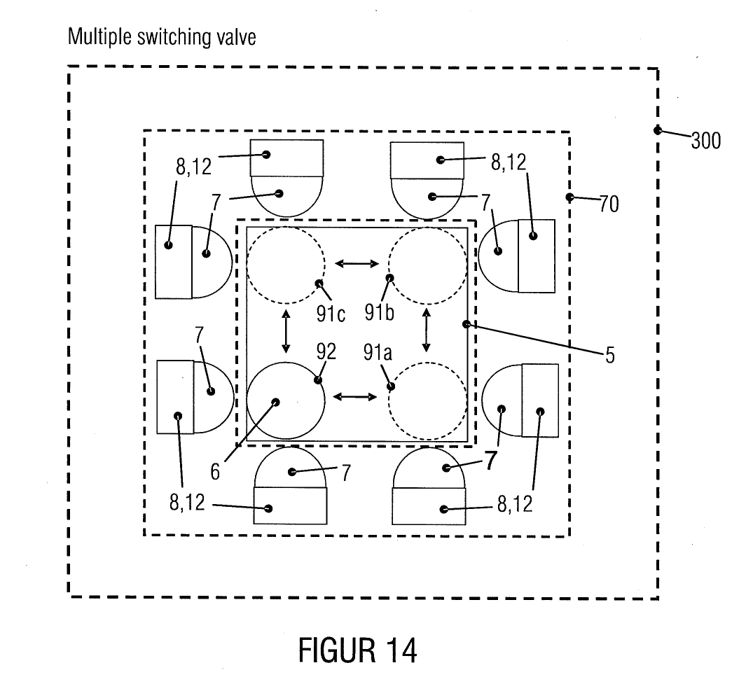

FIG. 14 shows a schematic representation of a cross-section through a multiple switching valve in accordance with an embodiment.

FIG. 1 shows a schematic longitudinal section through a switching valve 100 in accordance with an embodiment. The switching valve 100 comprises a fluid housing 5, a switching element 6 within the fluid housing 5, and an actuation means 70 outside the fluid housing 5. A fluid may flow through the fluid housing 5 when a fluid path 3, 4, which in this embodiment is determined by a fluidic inlet 4 and a fluidic outlet 3, comprises a first fluidic state, which describes, e.g., an opening of the valve, so that the fluid may flow through freely from the fluidic inlet 4 to the fluidic outlet 3. However, if the switching element 6 is in a second position 92, it may define a second fluidic state of the fluid path 3, 4 through the fluid housing 5 which differs from the first fluidic state and describes, e.g., a closed switching valve 100.

In the following, the first position will be referred to by the reference numeral 91, and the second position will be referred to by the reference numeral 92. This is not to express any preference. It would also be possible to refer to the first position 91 as the second position, and to refer to the second position 92 as the first position.

The switching element 6 is switched from one of the two positions 91, 92 to the other of the two positions 91, 92 by means of an impact-like force effect on the fluid housing 5 by the actuation means 70. For pulse transmission on the part of the actuation means 70 to the switching element 6 via the fluid housing 5, the fluid housing 5 is formed such that it comprises two position elements 93, 94 which stably position the switching element 6 in the first position 91 (by means of a first position element 93) or in the second position 92 (by means of a second position element 94). For example, the position elements 93, 94 may be formed as pockets so as to receive the switching element 6. The second position element 94 may also be formed as a seal seat so as to effect sealing toward the fluidic outlet 3.

When the switching element 6 is stably positioned in the first position 91, the switching element 6 may be located, for example, at a small distance from the right-hand side of the fluid housing 5, so that upon an impact of the actuation means 70 on the outer wall of the fluid housing 5 at a first external housing point 101, the pulse of the actuation means 70 may be transmitted to the switching element 6 in an almost loss-free manner. The switching element 6 may use the energy transmitted by the pulse to move from the first position 91 to the second position 92. That area of the fluid housing 5 across which the energy of the pulse is transmitted may also be referred to as a transmitter 108, 109.

In the following, a transmitter in the area of a fluid housing 5 configured as a rigid wall will be referred to by the reference numeral 109, and a transmitter in the area of a fluid housing 5 configured as a membrane will be referred to by the reference numeral 108.

The energy transmitted by the pulse may be used by the switching element 6 to overcome a potential barrier of potential energy, which causes the switching element 6 to remain in one of the two positions 91, 92, as well as further forces which prevent the switching element 6 from leaving the respective position 91, 92, so as to move from the first position 91 to the second position 92. The potential barrier of potential energy may be generated, for example, by a holding element 2 which comprises, for example, one or more springs so as to keep the switching element inside the fluid housing 5. A deflection of the one or more springs in the first position 91 or in the second position 92 may comprise, for example, a maximum possible length that is possible within the fluid housing 5. A resulting relaxation of the one or more springs while maintaining the spring elasticity represents a minimum of the potential energy and ensures stable positioning of the switching element 6 in the respectively adopted first position 91 or second position 92.

Other forces that prevent the switching element 6 from leaving one of the positions 91, 92 may be, e.g., frictional forces or forces created by the fluid. To overcome these forces as well as the force exerted on the switching element 6 by the holding element 2 configured, for example, as one or more springs, an energy will be used that is essentially referred to as breakaway energy and that may be transmitted to the switching element 6 from the actuation means 70.

For optimum pulse transmission from the actuation means 70 to the switching element 6, it is advantageous for the impact transmission to occur ideally at a first external housing point 101 or at a second external housing point 102, both external housing points 101, 102 being located on an actuation axis 105 formed by a first center of gravity 103 of the switching element 6 located in the first position 91, and by a second center of gravity 104 of the switching element 6 located in the second position. Under real-world circumstances, the impact will not always occur at the first 101 or second external housing point 102, but in an area around the two external housing points 101, 102 that is relatively small or relatively large, depending on the implementation of the actuation means 70 and of the switching element 6, i.e. in accordance with their manufacturing tolerances. Also, under real-world conditions, both external housing points 101, 102 are not necessarily located on the actuation axis 105.

In a further embodiment, however, pulse transmission may also take place when the external housing points 101, 102 and the centers of gravity 103, 104 of the switching element 6 located in the first position 91 and the second position 92 are no longer located on the actuation axis 105. However, in this embodiment, less efficient energy transmission of the actuation means 70 to the switching element 6 is to be expected, so that, for example for the breaking away of the switching element 6 from one of the two positions 91, 92, a higher energy than the breakaway energy may be used.

In the embodiment of FIG. 1 it may be seen that the switching element 6, which may be implemented, for example, as a spherical object, may comprise a sealing function and a placement function. The switching element may comprise a sealing function, e.g., in that, when adopting the second position 92, it will block, or seal, the fluid path 3, 4 at the fluidic outlet 3. The switching element 6 may have a placement function, e.g., in that, when adopting the second position 92, it may be placed against the interior wall of the fluid housing 5 or may be located in the proximity of the interior wall, so as to transmit a pulse of the actuation means 70. In this embodiment, the switching element 6 is implemented to comprise a sealing tolerance and a placement tolerance at various positions. What is to be understood by sealing tolerance and placement tolerance in this context are manufacturing tolerances that prescribe a certain level of accuracy of manufacturing the switching element 6 at those positions where the sealing tolerance and the placement tolerance are defined. In order to both block the fluidic outlet 3 and to be placed against the interior wall of the fluid housing 5, what is to be demanded is, for example, a high level of manufacturing accuracy of the switching element 6 at a placement position and at a sealing location.

In accordance with the invention, the actuation means 70 is accommodated outside the fluid housing 5. For example, the actuation means 70 may be located within a valve housing 11, which may be a housing that comprises the fluid housing 5 and the actuation means 70. The media separation thus effected is particularly advantageous with regard to the configuration of the actuation means 70, since the electronic devices thereof do not need to enter into direct contact with the fluid, so that an improved non-susceptibility to wear can be expected.

In the embodiment shown in FIG. 1, the actuation means 70 may comprise a contact element 7, a pusher element 8, and an energy store 1, as will be explained below in more detail with reference to FIGS. 2a and 2b.

FIG. 2a shows a schematic cross-section through the switching valve 100 in accordance with a further embodiment. The fluid housing 5, which may be connected, for example, to the valve housing 11, may have a switching element 6 located therein which comprises, for example, the shape of a sphere, and may have a first position element 93, which may be formed as a pocket in the first position 91, for example, and a second position element 94, which may be formed as a seal seat in the second position 92, for example, located therein. The holding element 2 may be formed by one or more springs, for example. In this embodiment, the fluid housing 5 comprises, at the location of the pulse transmission from the actuation means 70 to the switching element 6, which may also be referred to as a transmitter 108, a specific shape configuration that may be implemented as a membrane. Further elements of the fluid housing 5 may be a fluidic inlet 4 and a fluidic outlet 3. For performing the switching operation of the switching element 6, the valve housing 11 may have a pusher element 8, a converter element 12, and two contact elements 7 located therein, for example.

In addition, in this embodiment, two energy stores 1 are depicted which may be configured as preloadable springs, for example.

The actuation means 70 may comprise, for example, a converter element 12 and a contact element 7. The converter element 12 may serve, for example, to convert energy from an energy source provided to kinetic energy. The contact element 7 may serve to make contact between the contact element and the fluid housing 5 so as to effect the pulse-like force transmission to the switching element 6. In addition, the actuation means 70 may comprise a pusher element 8. The pusher element 8 may serve, for example, to transmit the kinetic energy, which has been converted by the converter element 12, to the contact element 7, it being possible for the pusher element 8 to be connected to the contact element 7. The pusher element 8 may also serve to attach the actuation means 70 to the fluid housing 5 or to a valve housing 11 comprising the fluid housing 5 and the actuation means 70.

It is feasible for the pusher element 8 and the converter element 12 to form a unit. The energy stores 1 are not absolutely necessary for the switching valve 100 to function. It is feasible for the energy stores 1 to form a unit either with the converter element 12 or the pusher element 8. In this example, the pusher element 8 may perform a rotary movement. The contact elements 7 may be connected to the pusher element 8, and may represent a mass together with the pusher element 8. It is feasible for the contact elements 7 to form a unit with the pusher element 8. The pusher element 8 may move across a certain range of angles without resulting in any contact between the contact elements 7 and the fluid housing 5 at the transmitter positions 108. The converter element 12 may receive energy from an electric, piezoelectric, hydraulic or pneumatic source of energy, and may generate a force in at least one of the directions of rotation of the pusher element 8. The pusher element 8 may be coupled to the converter element 12 such that the force effect of the converter element 12 to the pusher element 8 may lead to a rotary movement of the pusher element 8 and of the contact elements 7 in the corresponding direction of rotation.

The pusher element 8 may comprise a bearing 24 or a hinge 15, for example, it being possible for the kinetic energy of the converter element 12 to be transmitted from a first lever arm 301 of the pusher element 8 to the contact element 7 via a second lever arm 302 of the pusher element 8. A common lever axis 300 from the first lever arm 301 and the second lever arm 302 may be defined by an axis of the bearing 24 or of the hinge 15.

In a state of rest, i.e. in between two switching operations, the pusher element 8 may be in an angular position between the two largest possible rotational angles, respectively, of a direction of rotation, which in this example are defined by the transmitters 108 at the membranes.

For the switching operation of the switching valve 100, the converter element 12 may be supplied with energy and may drive at least the pusher element 8 along with the contact elements 7, which results in a rotary movement that may be implemented such that in a first phase of the rotary movement, at least the pusher element 8 and the contact elements 7 may receive kinetic energy, and that in a further phase of the rotary movement, said kinetic energy may be at least partly transmitted, in one impact operation on the part of one of the two contact elements 7, to one of the transmitters 108 at the membrane and to the switching element 6. Then the switching element 6 may move from a first position 91 to a second position 92, or may remain in said first position 91. The first position 91 and the second position 92 are determined, in this context, by the configuration of the fluid housing 5 in the form of position elements 93, 94, which position the switching element 6 in a stable manner.

The switching operation may occur in various degrees. Firstly, for example, the movement may proceed such that the contact element 7 is moved in the direction toward said transmitter 108 at the membrane from the beginning of the movement directly up to the impact. A further possibility consists in implementing the movement such that the contact element 7 is initially moved in the opposite direction, i.e. away from the transmitter 108, to be contacted, at the membrane, whereupon at least one of the energy stores 1 also receives energy, and the direction of movement is reversed at a specific rotational angle of the pusher element 8, and the contact element 7 moves toward said transmitter 108 at the membrane after the reversal.

Because of the impact operation in the energy transmission to the switching element 6, there is the possibility, for example, to generate an at least sufficiently large pulse to the switching element 6, so that the breakaway energy may be applied. For the impact operation it is advantageous for the switching element 6 to be in contact, prior to the impact, with the transmitter 108, to be contacted, at the membrane, or for the transmitter 108, to be contacted, at the membrane to be deformable at low energy consumption during the impact operation until it comes into contact with the switching element 6. The energy transmission may be most efficient, for example, if the impact occurs centrally, and if the effective mass of the parts moved, i.e. essentially of the pusher element 8 and of the contact elements 7, is approximately equivalent to the mass of the switching element 6 to be moved.

FIG. 2b shows a schematic longitudinal section through the switching valve 100 in accordance with the embodiment. The sectional plane 21 represents the plane through which the switching valve 100 may be cut in accordance with FIG. 2a so as to obtain the schematic longitudinal section of FIG. 2b. By means of the corresponding section, the pusher element 8, which in FIG. 2a has the shape of a clamp, is represented as two rectangular elements 8 in FIG. 2b. At the transmitter positions 108, i.e. at the positions where the pulse is transmitted from the actuation means 70 to the switching element 6, the fluid housing 5 has a membrane-shaped configuration. The pusher element 8 may be accelerated by an energy store 1 implemented as a spring element, so as to hit the membrane of the fluid housing 5 with the contact element 7 to give off the pulse to the switching element 6, which may switch from a first position 91 to a second position 92. In this embodiment, the switching element 6 is held in the first position 91 or in the second position 92 by a holding element 2 configured as a spring, the switching element 6 being able, in the first position 91, to unblock a fluid path 3, 4 through the fluid housing 5 (e.g. “valve open”), and being able, in the second position 92, to block the fluid path 3, 4 through the fluid housing 5 (e.g. “valve closed”).

FIG. 3a shows a schematic cross-section through the switching valve 100 in accordance with a further embodiment, which essentially differs from the embodiment of FIGS. 2a and 2b in that a drive unit comprising two converter elements 12 and two pusher elements 8 may be used. In this embodiment, the pusher element 8 comprises a bearing 24, it being possible for each of the two pusher elements 8 to comprise a bearing 24 of its own. With the converter element 12, the pusher element 8 may be deflected by means of a rotation about the axis of the bearing 24, so as to supply, upon the deflection, an energy store 1, configured as a preloadable spring, with the breakaway energy. Upon decharging of the energy store, or relaxing of the preloaded spring, the stored breakaway energy may become free from the energy store 1 so as to trigger the impact-like force effect on the fluid housing 5.

For example, the drive mechanism may be configured as an electromagnetic, electrostatic, piezoelectric, pneumatic, hydraulic drive, or as a manual drive with mechanical transmission. The preloadable spring may be preloadable in the opposite direction of the impact-like force effect on the fluid housing 5. In further embodiments, the converter element 12 may also give off the useful pulse to the fluid housing 5 without using an energy store 1, and may be configured, for example, as a piezoelectric bending converter, as a piezoelectric stack, as an electromagnetic drive, as an electrostatic drive, as a pneumatic drive, as a hydraulic drive, or as a manual drive with mechanical transmission.

The converter element 12 need not be permanently supplied with energy, for example. Energy supply is useful in order to move the switching element 6 from one of the two positions 91, 92, to the other of the two positions 91, 92. Once the desired fluidic switching state has been adopted, the energy supply may be decoupled from the converter element 12, for example.

FIG. 3b shows a schematic longitudinal section through the switching valve 100 in accordance with the embodiment. In this longitudinal section, one cannot see any difference from the embodiment of FIG. 2b. The section does not reveal that the pusher element 8 consists of two separate parts rather than being configured as a single part, as is the case in the second embodiment. While in the embodiment of FIGS. 2a/b a single converter element 12 takes over the energy conversion, in the embodiment of FIGS. 3a/b the energy conversion is performed using two converter elements 12.

FIG. 4a shows a schematic cross-section through the switching valve 100 in accordance with a further embodiment. FIG. 4a represents a top view, cut at a line of intersection 21, in accordance with FIG. 4b. In this embodiment, the actuation means 70 comprises a pulse generation unit selected as a piezo bending converter. However, this choice is not relevant to the fundamental functional principle depicted in FIGS. 4a/b. The piezo bending converter may represent both the converter element 12 and the pusher element 8, and be clamped at one end, and support the contact element 7 at the other end. In the area of the transmitter 109, which may be part of the fluid housing 5, the fluid housing 5 may be configured as a rigid wall, the rigid wall being able, for example, to conduct compression waves so as to transmit the pulse from the actuation means 70 to the switching element 6. The pulse may be given off to the rigid wall in the area of the transmitter 109. The piezo bending converter may be integrated, for example, in the pusher element 8 or the converter element 12 so as to undergo a deformation upon application of a voltage so as to accelerate the contact element 7 against the rigid wall 109 of the fluid housing 5. Due to the material properties of the rigid wall, e.g. a pressure wave is generated in the rigid wall 109 of the fluid housing 5 upon the impingement of the contact element 7 on the transmitter 109. The deformation occurring in the process happens abruptly, which enables efficient passing on of the pulse.

In this embodiment, the pusher element 8 is fixedly clamped at a first end along with the converter element 12 by means of a clamping 23. At a second end of the pusher element 8, which is connected to the contact element 7, the pusher element 8 is movable so as to transmit the kinetic energy present at the second end to the contact element 7 and to give off the pulse to the fluid housing 5.

FIG. 4b shows a schematic longitudinal section through the switching valve 100 in accordance with the embodiment. FIG. 4b represents the lateral view, cut at the intersection line 21 of FIG. 4a.

FIG. 5a represents a schematic cross-section through the switching valve 100 in accordance with a further embodiment. FIG. 5a represents a top view, cut at the intersection line 21 of FIG. 5b. The representations of FIGS. 5a/b are derived from FIGS. 4a b. Instead of the piezo bending converter of FIGS. 4a/b, a piezostack may be employed as the converter element 12, and consequently the dimensions of the valve housing 11 may be reduced. In addition, for example, the pusher elements 8 may be omitted if a converter element 12 having contact elements 7 deposited thereon is mounted on each of the sides of the fluid housing 5. Also, an adapted clamping 23 may be provided.

FIG. 5b shows a longitudinal section through the switching valve 100 in accordance with the embodiment. FIG. 5b corresponds to the lateral view, cut at the intersection line 21 of FIG. 5a. In this embodiment, the fluid housing 5 is formed, in the area of the transmitter 109, as a rigid wall, so that the impact from the piezostack of the converter element 12 may be transmitted via the contact element 7 to the transmitter 109 of the fluid housing 5 and on to the switching element 6. Space can be saved by utilizing a piezostack as the converter element 12. The clamping 23 of the converter element 12 may also be configured to be smaller than in the figures shown above.

FIG. 6 shows a schematic cross-section through the switching valve 100 in accordance with a further embodiment. It is the principle of this arrangement to use only a single converter element 12, which acts on both transmitters 109 at the rigid wall at the same time, for example due to a specific design of the pusher elements 8, so that with each actuation of the converter element 12, the switching element 6 may be switched to the next position. The pusher elements 8 may be fixed via solid hinges 15. Said solid hinges 15 may be mounted, for example, on the fluid housing 5, but they may just as well be mounted on the valve housing 11 in any suitable position.

A force effect of the converter element 12 on the pusher element 8 may be transmitted to a second lever arm 302 via a first lever arm 301, so as to push the contact element 7 at the rigid wall 109, in the transmitter area, against the fluid housing 5. The first lever arm 301 is formed, for example, by a point of a force effect of the converter element 12 on the pusher element 8 and an axis 300 of the hinge 15, or solid hinge. The second lever arm 302 is formed, for example, by a point of a force effect of the contact element 7 on the fluid housing 5 and the axis 300 of the hinge 15.

FIG. 7 shows a cross-section through the switching valve 100 in accordance with a further embodiment. Pulse generation may be effected in that the converter element 12 initially preloads the pusher element 8 against an energy store 1. Then, the pusher element may be released, the energy store 1 may accelerate the pusher element 8 in the opposite direction, so that the pusher element 8 may impinge upon the transmitter 109 in the area of the rigid wall. This arrangement is also a good example of the fact that the converter element 12 need not be a piezoelement, but may be, for example, an electromagnetic drive. The converter element 12 may operate in accordance with any drive principle for any assembly variants, e.g. electromagnetic, electrostatic, piezoelectric, pneumatic, hydraulic, etc. Also, manual actuation with mechanical transmission is feasible.

A further advantage of embodiments of the invention, for example of embodiments in accordance with FIG. 7, is that it is also possible to realize a switching valve 100 that is safely closed in a currentless manner, i.e. when there is a power failure, the valve 100 will close, unless it is already closed anyway. For specific applications, for example in automation technology, this aspect may be very important so as to be able to transfer an installation into a safe state in the event of a power failure.

What is feasible, for example, is an embodiment in accordance with FIG. 7, in which case the actuation means 70 on the right-hand side, which is responsible for a switching operation of “closing” the valve 100, is configured such that in the energized state, it will usually be preloaded, e.g. by means of an electromagnet which pulls the pusher element 8 counter to the spring 1. If there is a power failure, the actuation means 70 will switch once again, since the electromagnet will release the preloaded pusher element 8, and in the event of an open valve 100, said valve will be closed. In the event of the valve 100 being already closed, said valve will remain closed.

While this case of a valve 100 closed in a currentless manner entails increased expenditure of energy since the actuation means 70 for closing the switching valve 100 may make use of a steady power supply for closing the switching valve 100, for example, there may be cases of application where this is accepted because of the increased work safety etc. that is thereby achieved.

FIG. 8a shows a longitudinal section through a switching valve 100 in accordance with a further embodiment, with the switching element 6 in a first position 91. In this embodiment, the first position 91 corresponds to the open switching valve 100. The consideration behind this arrangement is that on account of manufacturing tolerances in the previously shown arrangements, for example, it cannot be ensured that the switching element 6 can be placed against the transmitter 109 of the rigid wall and can sealingly close the fluidic outlet 3 at the same time. In particular the first requirement, however, may be indispensable to ensure flawless operation of the switching valve 100. Therefore, in this embodiment, the sealing function of the switching element 6 may be decoupled from the placement function at the transmitter 109 of the rigid wall in that the switching element 6 is rigidly connected to a pulse receiver 16 and may be pivoted about a rotational axis of a rotational element 19. Upon actuation of, e.g., the left-hand converter element 12, the pulse transmitted from the contact element 7 may be received by the pulse receiver 16 so as to accelerate the pulse receiver 16 to the right while twisting the switching element 6 that may be coupled to the pulse receiver 16 via a rigid connection element 17, such that the flow of the fluid through a bore 18 within the switching element 6 and through the following fluidic outlet 3 is interrupted. The opening operation may be performed analogously by actuating, e.g., the right-hand converter element 12.

FIG. 8b shows a longitudinal section through the switching valve with the switching element 6 in a second position 92 in accordance with the embodiment. Due to the rotation of the switching element 6 from the first position 91 to the second position 92, the flow of fluid along the fluid path 3, 4 is interrupted, since in this embodiment the bore 18 is no longer arranged such that the fluid can flow through it. In this embodiment, the switching element 6 may comprise a pulse receiver 16, a rotational element 19 with a bore 18, as well as a rigid connection element 17 for rigidly connecting the pulse receiver 16 to the rotational element 19. The pulse receiver 16 may be configured to receive a pulse of the impact-like force effect on the fluid housing 5 and to transmit the pulse to the rotational element 19 via the rigid connection element 17.

The rotational element 19 may be configured to transform the pulse to a rotational movement so as to move the switching element 6 from one (91) of the two positions 91, 92 to the other (92) of the two positions 91, 92, and the rotational element 19 may be configured to unblock, in the first position 91, the fluid path 3, 4 through the fluid housing 5 while fluid is flowing through the bore 18 (e.g. “switching valve open”), and to block, in the second position 92, the fluid path 3, 4 through the fluid housing 5 on account of the rotation of the bore 18 with the rotational element 19 (e.g. “switching valve closed”). The pulse receiver 16 may be configured to adopt two positions 91, 92, which are associated with the positions 91, 92 of the switching element 6. The sealing tolerance of the switching element 6 may be realized, for example, by means of the rotational element 19, and the placement tolerance of the switching element 6 may be realized, for example, by means of the pulse receiver 16. In this manner, both manufacturing tolerances may be decoupled from each other so as to simplify manufacturing of the switching element 6.

FIG. 9a shows a longitudinal section through the switching valve 100 in accordance with a further embodiment. FIG. 9a shows the lateral view, cut at the intersection line 21 of FIG. 9b. This arrangement follows the same idea that was also implemented in FIGS. 8a/b. For example, the manufacturing tolerances cannot guarantee simultaneous placement against the transmitter 109 and a simultaneous sealing function. This is why, by utilizing two springs 28, 29, the switching element 6 may be positioned in the first position 91 and in the second position 92. The holding element 2 in accordance with FIG. 1 may comprise two springs in this embodiment, for example a first spring 28 for attaching the switching element 6 to an upper end within the fluid housing 5, and a second spring 29 for attaching the switching element 6 to a lower end within the fluid housing 5.

The first spring 28 and the second spring 29 are arranged, for example, within the fluid housing 5 such that the switching element 6 may move, while applying the breakaway energy, from one of the two positions 91, 92 to the other of the two positions 91, 92, and may be held, during this movement, by the two springs 28, 29 of the holding element 2. The two springs 28, 29 may be configured such that in each of the first position 91 and the second position 92, they have a maximum possible spring deflection without leaving an elastic area of the springs 28, 29 so as to form the potential barrier that prevents the switching element 6 from changing from one of the two positions 91, 92 to the other of the two positions 91, 92 without any exterior energy effect. It is not before the pulse transmission from the actuation means 70 to the switching element 6 via the fluid housing 5 that the switching element 6 can receive kinetic energy which enables the switching element 6 to switch from the second position 92 to the first position 91, or vice versa, while the two springs 28, 29 are contracted and while any other forces, for example frictional forces and flow forces, are overcome.

In this embodiment, the switching element 6 is configured, for example, to unblock, while in the first position 91, a first fluid path 31, 4 through the fluid housing 5 and to block a second fluid path 32, 4 through the fluid housing 5, the second fluid path 32, 4 differing from the first fluid path 31, 4. However, in the second position 92, the switching element 6 may be configured to unblock the second fluid path 32, 4 through the fluid housing 5, and to block the first fluid path 31, 4 through the fluid housing 5. In this embodiment, for example, the sealing tolerance and the placement tolerance is to be related to the same surface area of the switching element 6, since at the same position, e.g., the pulse may be transmitted and one of the fluid paths 31, 4 or 32, 4 may be sealed off or blocked.

In this embodiment, the two fluidic outlets 31, 32 are also arranged at the transmitter positions 109, i.e. at those positions where the pulse may be transmitted from the wall of the fluid housing 5 to the switching element 6. Pulse transmission may thus be effected across an area, which is annular, for example, and where the switching element 6 is placed against the fluid housing 5 in the transmitter area 109. In the preceding embodiments, by contrast, pulse transmission ideally could be performed via a single point, for example as Hertz-calculated stresses, specifically for the event that the switching element 6, which was implemented as a sphere, for example, was placed against the wall of the fluid housing 5 in one point. In the embodiment, the fluidic outlet 31, 32 may comprise a round opening, for example, it being possible for the center of the circle of the opening to be located on the actuation axis 105 so as to ensure that the pulse is passed on as centrally as possible from the fluid housing 5 to the switching element 6.

In addition, FIG. 9a also shows by way of example that, by using this functional principle, multiple-way valves, i.e. valves with more than one fluidic inlet and outlet, may also be realized. FIG. 9a shows, e.g., a 3/2-way valve having a fluidic inlet 4 and two fluidic outlets 31 and 32, which may be opened in an alternating fashion. In general terms, switching valves 100 having any number of inlets and outlets may be realized by suitably arranging possibly several switching elements 6 and converter elements 12, which may be positioned accordingly.

FIG. 9b shows a schematic cross-section through the switching valve 100 in accordance with the embodiment. FIG. 9b represents the top view, cut at the intersection line 21 of FIG. 9a. One may recognize the two fluidic outlets 31, 32 as well as a spring 28 of the holding element 2. The second spring 29 may be located above the sectional plane due to the sectional representation, so that it cannot be viewed in this sectional representation. The actuation means 70 may comprise, for example, a clamping 23 so as to clamp the converter element 12, the pusher element 8 and the contact element 7 at an upper end. The converter element 12 may be configured as a piezoelectric bending converter, for example, so as to perform, due to a change in the length of the pusher element 8, an impact-like movement directed at the contact element 7 so as to transmit the impact in the area of the transmitter 109 of the fluid housing 5 to the switching element 6.

This embodiment shows that the actuation means 70 may comprise two converter elements 12, two pusher elements 8 and two contact elements 7. In one embodiment, it is also possible for both converter elements 12 to be supplied with energy, so that both contact elements 7 will impinge on the fluid housing 5 in the area of the transmitters 109. The pulse may then be transmitted, e.g., at both transmitter positions 109 via the fluid housing 5, but will impinge on the switching element 6 only at one transmitter position 109, which switching element 6 is placed against the interior wall of the fluid housing 5 in the area of the corresponding transmitter position 109. The second pulse transmission will, for example, find no switching element 6, so that the second pulse may travel through the fluid housing 5 and be attenuated by the fluid housing 5. Simultaneous actuation of the two converter elements 12 therefore cannot be considered to be energy-efficient, but has the advantage that in order to trigger the switching operation, no information is required in terms of which of the two positions 91, 92 the switching element 6 has currently adopted.

A further advantage of these examples of application, wherein both converter elements 12 are supplied with energy, is that the switching valve 100 will usually adopt that state for which the switching operation is triggered. For example, controlling a “closed” or “close valve” state will usually lead to a closed valve 100, and controlling an “on” or “open valve” state will usually result in an open valve 100.

FIG. 10 shows a schematic longitudinal section through the switching valve 100 in accordance with a further embodiment. In this embodiment, the fluid housing 5 may comprise a sealing element 13, for example, it being possible for said sealing element 13 to be configured to switch off the passage of the fluid through the fluid housing 5 along with the switching element 6, which is in the second position 92. By means of the sealing element 13, production of the switching element 6, for example, may be simplified, since inaccurate sealing tolerance may be compensated for by the sealing element 13. For example, the sealing element 13 may be configured as a ring of plastic so as to seal off a spherically designed switching element 6 against the fluid housing 5. For reliably sealing off the fluidic outlet 3 while, at the same time, the switching element 6 is placed against the transmitter 109 of the fluid housing 5, the second position 92, for example, which is defined by a position element 94 and results in the “valve closed” switching position, may be implemented by means of a sealing element 13. The sealing element 30 may also simplify manufacturing of the switching element 6, since, for example, it is no longer possible to simultaneously comply with two tolerances in two different positions, but the sealing tolerance is effected by the sealing element 13, and the placement tolerance is effected by the switching element 6.

FIG. 11 shows a schematic longitudinal section through the switching valve 100 in accordance with a further embodiment. The pulse transmission from the contact element 7 to the switching element 6 may be performed, for example, by a transmitter 108, it being possible for this transmission mechanism to result in the implementation of the media separation, i.e. the fluid contained within the switching valve 100 has no contact with any elements of the pulse-generating converter element 12, but only with, e.g., the interior sides of the fluid housing 5 and with, e.g., the switching element 6. FIG. 11 shows an example wherein the transmitter 108 is not identical with the fluid housing 5, but may be configured as a separate component which may be sealingly connected to the fluid housing 5, so that no fluid may escape. This may result in the possibility of selecting the transmitter 108 to be made of a different material than the fluid housing 5, for example, to be made of an elastic material which may compensate for potential manufacturing tolerances more readily. Thus, it may be sufficient for the switching element 6 to keep to a sealing tolerance and to keep to less restrictive requirements in the field of a placement tolerance.

Combinations of the embodiment of FIG. 11 and the embodiment of FIG. 10, or other embodiments, are also possible, so that, for example, due to a membrane in the area of the transmitter 108 and due to a sealing element 13 in the area of the fluidic outlet 3, no strict levels of manufacturing accuracy regarding the placement tolerance and the sealing tolerance need to be complied with. In this case, for example, the switching element 6 could be produced in an even simpler manner since it would need to comply neither with strict sealing tolerance nor with strict placement tolerance.

FIG. 12 shows a schematic longitudinal section through the switching valve 100 in accordance with a further embodiment. The difficulty that with manufacturing tolerances, for example, no simultaneous sealing and placement function of the switching element 6 can be ensured may also be circumvented with the variant shown in accordance with FIG. 12. The pulse generated by the converter element 12 may be transmitted, for example, by the contact element 7 via the transmitter 109, to an intermediate element 14, which in this embodiment is implemented to be spherical, but may also be implemented to be cylindrical, for example, or may have any other shape. This intermediate element 14 may then be accelerated, for example, in the direction of the switching element 6, so as to give off its kinetic energy to the switching element 6, by means of which the change of the switching element 6 from a first position 91 to a second position 92, or vice versa, may be triggered. Reliable functioning of this principle may also be achieved, for example, by a return spring 20, which may achieve placement of the intermediate element 14 against the transmitter 109 in a state of rest. It would also be feasible, for example, to use a magnetic return mechanism for the intermediate element 14 instead of the return spring 20.

For example, the fluid housing 5 may be configured to effect—by utilizing the two intermediate elements 14 whose centers of gravity are ideally located on the actuation axis 105 within the fluid housing 5 and are movable on this actuation axis 105—pulse transmission from the actuation means 70 to the switching element 6 via one of the two intermediate elements 14 so as to move the switching element 6 from one of the two positions 91, 92 to the other of the two positions 91, 92. For example, the fluid housing 5 may be implemented to return the two intermediate elements 14 to their rest positions by using a return spring 20, said two intermediate elements 14 being placed, for example, upon assuming their rest positions, against two opposite interior walls of the fluid housing 5 so as to be able to effect pulse transmission. By using the two intermediate elements 14, the placement tolerance of the switching element 6 may be increased, for example, i.e. manufacturing of the switching element 6 may be simplified in that the placement position need not be configured with as high a level of accuracy as would be useful, for example, in the embodiment of FIG. 1. In further embodiments, it would also be feasible to employ only one intermediate element 14 or several intermediate elements 14.

FIG. 13 shows a representation of a method 200 for switching a switching valve 100. The method 200 may comprise, for example, a first step 201, which comprises applying an impact-like force effect on the fluid housing 5 with the actuation means 70, so as to cause a pulse-like transmission of force to the switching element 6 in order to move the switching element 6 from a first position 91 to a second position 92, the switching element 6 in the first position 91 defining a first fluidic state of a fluid path 3, 4 through the fluid housing 5, and the switching element 6 in the second position 92 defining a second fluidic state of a fluid path 3, 4 through the fluid housing 5, which second fluidic state differs from the first fluidic state.

The method 200 may be performed by the first step 201, the first step 201 describing, for example, a switching operation of the switching valve 100. Upon switching back to the original state or to a further state, the first step 201 may be performed again. Also, the first step 201 may be performed once or several times in a row in order to switch multiple-way switching valves.

FIG. 14 shows a schematic representation of a cross-section through a multiple switching valve 300 in accordance with an embodiment. The multiple switching valve 300 comprises, in this embodiment, four resting positions wherein the switching element 6 may stably adopt the positions 92, 91a,b,c.

In this embodiment, the actuation means 70, which is mounted outside the fluid housing 5, comprises eight combinations with contact elements 7, pusher elements 8 and converter elements 12. By suitably controlling the converter elements 12, the switching element 6 may adopt any of the four positions 92, 91a,b,c. By simultaneously or approximately simultaneously controlling two converter elements 12, it is also possible, for example, to place the switching element 6 in an opposite position, for example from position 92 to position 91b.

The multiple switching valve 300 may be used, for example, to implement a multiple-way valve, e.g. a mixing valve that may effect mixing of several fluids in accordance with a predetermined mixing ratio.

In further embodiments, the multiple switching valve 300 may also be operated with more than one switching element 6, for example with two switching elements 6 in accordance with FIG. 14. Both switching elements 6 may have fixed positions 91, 92a,b,c assigned to them, for example positions 92 and 91a for a first switching element 6, and positions 91b and 91c for a second switching element 6. In addition, it would also be possible to let the switching elements 6 move while adopting each of the positions 92, 91a,b,c within the fluid housing 5, for example in dependence on controlling the converter elements 12.

Further advantages of embodiments of the invention will be set forth below. A switching valve 100 may comprise, for example as a first functional feature or functional variant, that a changeover is realized by impact actuation in accordance with the representation of FIGS. 4a/b. A second functional feature may consist in the locking positions of the switching element 6 which are defined by the position elements 93, 94 and are also depicted in FIGS. 4a/b. A third functional feature may be the potential barrier existing between the two positions 91, 92. The potential barrier is also depicted in FIGS. 4a/b. The valve inlet 4 and the valve outlet 3, which are also depicted in FIGS. 4a/b, may be regarded as a fourth functional feature.

While a basic principle of the switching valve 100 may be described by means of the four functional features described, a further partial aspect is the aspect of pulse generation by the switching valve 100. In accordance with the depiction in FIGS. 4a/b, 8a/b, 9a/b, and 11, the pulse may be generated by a piezo bending converter, for example. Pulse generation may be performed by a piezostack in accordance with the representations in FIGS. 5a/b, 10 and 11. Pulse generation may be effected by a piezostack having a deflection mechanism which is fixed by means of a solid hinge 15, in accordance with the depiction in FIG. 6. Pulse generation may be effected by preloading the pusher element 8 against an energy store 1 and by pulse transmission upon swing-back in accordance with the depiction in FIG. 7. Pulse generation may be effected by an electromagnetic drive, for example in accordance with FIG. 7, or by a hydraulic drive, an electrostatic drive, a pneumatic drive, or by a manual actuation means 70 with mechanical transmission.

A further partial aspect of the switching valve 100 is, e.g., the implementation of the switching positions by the position elements 93, 94, or the positions 91, 92. For example, the holding element 2 may urge the switching element 6 into the position element 93, 94, which forms the first position 91, or the second position 92. This is depicted, for example, in FIGS. 4a/b, 5a/b, 6, 7, 10, 11, and 12. In addition, the pulse receiver 16 may twist a rigidly connected switching element 6, which is depicted in FIGS. 8a/b. Also, the switching positions 91, 92 may be realized by two opposite holding elements 2, which is depicted, for example, in FIGS. 9a/b.

A further partial aspect of the switching valve 100 may be the pulse transmission that may be effected, for example, to a rigid wall, i.e. the transmitter 109 may be part of the fluid housing 5. This is depicted, for example, in FIGS. 4a/b, 5a/b, 6, 7, 8a/b, 9a/b, and 10. The pulse may be transmitted to a flexible membrane, which is depicted in FIG. 11, for example. The pulse may also be transmitted to a rigid wall with a spring-loaded intermediate body 14, which is depicted in FIG. 12 by way of example.

A further partial aspect of the switching valve 100 may be the mode of operation of the sealing. Said sealing may be effected, for example, by means of an elastic insertion element or a sealing element 13, which is depicted, for example, in FIG. 10.

Further advantages of switching valves 100 in applications of inventive embodiments may be gathered from the description which follows.

Switching valves 100 may be used in many applications where it is essential to control one of two fluidic states 91, 92, referred to below as switching states or positions, e.g. two switching states 91, 92 having different fluidic resistances, and to then maintain this state without any further energy consumption. This relates to, e.g., automation technology including pneumatics as well as process technology, automobile technology, or medical technology. If toxic, aggressive or sensitive fluids, for example chemicals, fuels or body fluids, are to be controlled, care is to be taken to ensure a high sealing function within the switching valve, or valve, 100. In addition, media separation may be useful for reasons of safety or tolerability. Any contact with the fluid may cause problems, among others, for important components of the drive, such as electronic assemblies, resistors, coils, or bending converters.

In the most favorable case, the valve 100 will be implemented such that that area of the valve 100 which is filled with fluid or contacted by fluid will only have such elements of the valve 100 located therein which are compatible with the fluid. For the valve 100 contemplated here, this includes, in addition to a fluid housing, or fluidic housing, 5, at least one controllable switching element or fluidic switching element 6, at least two position elements 93, 94, and at least one holding element 2. In this context, the fluidic housing 5 represents essentially that part of the valve 100 which comes into contact with the fluid, within which the fluid is guided, and where the various fluidic resistances are implemented in accordance with the switching states 91, 92.

Due to its geometric position within the fluidic housing 5, the fluidic switching element 6 effects the adoption of the two switching states 91, 92. The position elements 93, 94 serve at least for spatially positioning the fluidic switching element 6 in one of the two switching states 91, 92, respectively. They are made in such a way that in each of the switching states 91, 92, a different fluidic state results, for example a different flowing-through with a different fluidic resistance. The position elements 93, 94 consist of at least one seat wherein the fluidic switching element 6 positions itself in a switching state 91, 92—at least with the cooperation of the holding element 2—such that the desired fluidic resistance results. The holding element 2 has the task, inter alia, to ensure that a sufficient force acts on the fluidic switching element 6 when the fluidic switching element 6 is positioned in a position element 93, 94, and that the potential energy of the fluidic switching element 6 in each of the positions 91, 92 defined by the position elements 93, 94 has a minimum, and that the potential energy of the fluidic switching element 6 at any other location is at least larger than the minimum potential energy in one of the positions 91, 92 defined by the position elements 93, 94. Generally speaking, the fluidic switching element 6, the holding element 2, and the position elements 93, 94 are made such that the fluidic switching element 6 is typically located in one of the positions 91, 92, except during the switching operations.

For the operation of switching the valve 100 from one switching state 91 to the other 92, the fluidic switching element 6 suitably may have at least as much energy supplied to it, or have such a force exerted on it, that it may overcome the potential barrier as well as other forces that prevent the fluidic switching element 6 from leaving the position 91, 92, such as frictional forces or forces generated by the fluid. The force for overcoming said other forces will be referred to as breakaway force below.

To achieve a high sealing function, the fluidic switching element 6 may be implemented as a sphere, for example, and the two position elements 93, 94 may be implemented as recesses. The holding element 2 may then consist of a spring, for example. In addition, suitable slides, flaps, pistons or lids are also feasible as the fluidic switching element 6, depending on the requirements. Apart from the fluidic inlets 4 and outlets 3 that may be used, the fluidic housing 5 comprises, at the most, such further penetrations that cannot be permanently passed by the fluid, but through which the drive energy may be introduced. To this end, the valve housing 11 may be manufactured, for example, from only one single material or from various materials, several housing parts being sealingly interconnected in a firmly bonded or a non-positive manner, for example. With this type of media separation, the introduction of the energy that may be used for the switching operations frequently poses a technical problem for which there may be various solutions which will be illustrated here by way of example.

The first example cited may be that the energy supply may be effected by means of a magnetic field, it being possible for the field lines to pass, without being substantially impaired, a fluidically non-penetrable housing made of suitable non-magnetic materials.

A further possibility of energy transmission is to exploit the inertia of the mass of the fluidic switching element 6 of the valve 100 so as to transfer the fluidic switching element 6 from one switching state 91 to the other 92. Such an energy transfer is known in the context of acceleration sensors as are used, for example, in cars for triggering airbags. Since in this context, the entire fluidic housing 5 may be accelerated, a poorer energy balance will result in addition to the unfavorable movement of the fluidic housing 5.

A further example is a mechanical drive wherein the energy acting on the fluidic switching element 6 of the valve 100 is introduced into by a comparatively slow variable force that is effective over a specific distance virtually for the entire duration of the switching operation, as may be implemented, e.g., via leak-proof bellows.

A further possibility of a mechanical drive consists in that the energy is transmitted to the switching element or fluidic element 6 within a comparatively short period of time, which is shorter than the time taken up by the operation of switching the fluidic switching element 6 from the one 91 to the other switching state 92. This may be effected with a type of impact operation by means of at least one suitable transmitter 108, 109, whose task it is to mechanically transmit the energy that may be used from a source located outside the fluidic housing 5 to the fluidic switching element 6 located within the fluidic housing 5. The transmitter 108 may be a membrane, for example, which is part of the fluidic housing 5, or any other elastically deformable area of the fluidic housing 5. The time period of the deformation of the transmitter 108 for the purpose of energy transmission by means of the impact operation is shorter than the time that passes during the operation of switching the fluidic switching element 6, i.e. while moving it from the one 91 to the other position 92. In the impact operation, the fluidic switching element 6 receives so much kinetic energy that it can apply the breakaway force and overcome the potential barrier.

Because of the type of the pulse transmission, the force acting on the switching element 6 is at its largest precisely when it is appropriate, namely at the very beginning of the movement, when the breakaway force is applied, so that anything moves at all. Once this breakaway force has been overcome, for example the static friction, etc., not as much energy will need to be supplied to maintain the movement to the other resting position. The time curve of the force that may currently be used for moving the switching element 6 from one position to the other 91, 92 may be referred to, for example, as an ideal force characteristic of the switching element 6. The force characteristic that may be generated with the pulse-like drive or with the actuation element 70 comes very close to this ideal force characteristic, which entails advantages in terms of energy efficiency.

For illustration purposes, the central impact of two billiard balls having the same mass shall be stated, where the impacting ball rests after the impact and has transmitted its pulse and the kinetic energy entirely to the ball impinged upon, which will move accordingly after the impact.

The action of the transmitter 108, 109 may be illustrated very well by means of the physical pendulum test, where e.g. five identical elastic balls, e.g. K1-K5, are suspended in a horizontal line by means of vertical threads. If one of the outer balls, e.g. K1, is deflected and impinges, when swinging back, on that ball which is now the outermost of the balls at rest, e.g. K2, it will give off its energy to the other, initially outermost, ball, i.e. K5, during which process the balls K2, K3 and K4 will remain virtually at rest. The balls K2, K3 and K4 have performed virtually no movement, but have only been subject to the deformations that are useful for transferring the energy. This latterly described possibility will be referred to as impact actuation below. In this process, the mechanical energy that may be used for the impact actuation is generated by a converter element 12.

In a series of valves, the energy consumption is critical and may be minimized. One may, for example, think of telemetrically controlled valves at such positions in machines that are difficult to access. Therefore, it is important, first of all, to take care to ensure that the valve 100 receives energy only while being switched from one switching state 91 to the other switching state 92, and does not consume any energy in between switching operations. The switching state 91, 92 is defined by the fluidic switching element 6 with the cooperation of at least one holding element 2 and, for example, of the position elements 93, 94. In the switching operation, the fluidic switching element 6 can be moved from a first position 91 to a second position 92, the fluidic state, for example the fluidic resistance of the fluid flowing through the valve 100, in one of the positions 91 being different from the fluidic state in the other position 92. The switching state 91, 92 may be maintained by means of the holding element 2, wherein the potential energy of the fluidic switching element 6 may adopt a minimum for each of the two switching states 91, 92, and wherein a potential barrier may be located between the positions 91, 92 of the fluidic switching element 6.

In addition to locking the fluidic switching element 6, e.g. a sphere, by means of the holding element 2, which may be a spring, as is depicted in the embodiment selected, a magnetic locking may also be implemented, wherein at least one permanent magnet is employed, for example. In particular the ability to remain in the two positions 91, 92, e.g. in the event of shocks, the energy consumption and the fluidic properties may be influenced by the nature of the fluidic switching element 6, of the holding element 2 and of the position elements 93, 94.

In particular with valves 100 controlling a liquid, care is to be taken to ensure that the movement of the fluidic switching element 6 may be attenuated by the viscosity of the liquid, which may influence the energy consumption per switching operation. The attenuation may also be exploited in an advantageous manner so as to improve the dynamic behavior of the fluidic switching element 6, e.g. to minimize the influence of transients, by means of which safe adopting of the positions 91, 92 predefined by the position elements 93, 94 is achieved. In addition, care is to be taken to ensure that the fluidic switching element 6 is prevented, by frictional and adhesive forces as well as by forces exerted by the fluid, from leaving the respective position 91, 92. Therefore, at least a corresponding breakaway force with regard to the position elements 93, 94 is to be applied, for example for the switching operation of the fluidic switching element 6, in addition to the energy for overcoming the potential barrier. For driving the fluidic switching element 6, this means that in addition to the force for overcoming the potential barrier, the breakaway force is to be applied already at the beginning of the movement process of the fluidic switching element 6.

Embodiments of the present invention comprise various implementations of valves 100 having drives with impact actuation and media separation as described above. This means that the actual converter elements 12 of the valve 100, which generate the kinetic energy or the forces that may be used for the switching operation from an electric or pneumatic energy source by means of conversion, are located outside the fluidic housing 5 of the valve 100.

Electromagnetic drives, piezoelectric bending converters, piezoelectric stack converters, or pneumatic drives may be employed, among others, as converter elements 12. The converter elements 12 as well as the electronic circuits for providing the electric voltages or currents that may be used for the drive shall not be addressed in more detail here, since they are known, in principle, in accordance with conventional technology.

An embodiment of the switching valve 100 comprising impact actuation is depicted in FIGS. 2a/b. The fluidic housing 5, which is connected to the valve housing 11, has a fluidic switching element 6 in the shape of a sphere as well as a first position element 93 in the first position 91 as a pocket and a second position element 94 in the second position 92 as a seal seat implemented therein. The holding element 2 is formed by a spring. The two transmitters 108 are each formed by a membrane as part of the fluidic housing 5. Further elements of the fluidic housing 5 are the fluidic inlet 4 and the fluidic outlet 3. In order to perform the switching operation of the fluidic switching element 6, a pusher element, or pusher, 8, a converter element 12, and two contact elements 7 are located within the valve housing 11. Also, two energy stores 1 are depicted which in the embodiment are implemented as springs. It is feasible for the pusher 8 and the converter element 12 to form a unit. The energy stores 1 are not absolutely necessary for the valve 100 to function. It is feasible for the energy stores 1 to form a unit either with the converter element 12 or with the pusher 8. In this example, the pusher 8 may perform a rotational movement. The contact elements 7 are connected to the pusher 8 and represent a mass together with the pusher 8.

It is feasible for the contact elements 7 to form a unit with the pusher 8. The pusher 8 may move over a certain range of angles without there being any contact between the contact elements 7 and the transmitters 108. The converter element 12 may receive energy from an electric or pneumatic source of energy and may generate a force in at least one of the directions of the rotational movement of the pusher 8. The pusher 8 is coupled to the converter element 12 such that the force of the converter element 12 results in a rotational movement of the pusher 8 and of the contact elements 7 in the corresponding direction of rotation.

In the state of rest, i.e. in between two switching operations, the pusher 8 is located in an angular position between the two maximum possible rotary angles, respectively, of a direction of rotation, which in this example may be defined by the transmitters 108.

For the switching operation of the valve 100, the converter element 12 is supplied with energy and drives at least the pusher 8 together with the contact elements 7, which results in a rotary movement of such a nature that, in a first phase of the rotary movement, at least the pusher 8 and the contact elements 7 receive kinetic energy, and that, in a further phase of the rotary movement, this kinetic energy is at least partly transmitted, during an impact operation, to one of the transmitters 108 and to the fluidic switching element 6 by one of the two contact elements 7. Subsequently, the fluidic switching element 6 moves from a first one 91 of the position defined by the position element 93 to the other one 92 of the position defined by the position element 94, or it remains in said first position 91.

The switching operation may be effected in various implementations. At first, the movement may be such, for example, that the contact element 7 is moved in the direction of said transmitter 108 from the beginning of the movement directly up to the impact. A further possibility consists in configuring the movement such that the contact element 7 is initially moved in the opposite direction, i.e. away from the transmitter 108 to be contacted, whereupon also at least one of the energy stores 1 will receive energy, and the direction of movement will be reversed at a specific rotary angle of the pusher 8, and the contact element 7 will move toward said transmitter 108 following the reversal.

In any case, due to the impact operation in the energy transmission to the fluidic switching element 6, there is a possibility of generating an at least sufficiently large force acting on the fluidic switching element 6 that the breakaway force may be applied. For the impact operation it is advantageous when the fluidic switching element 6 is in contact, prior to the impact, with the transmitter 108 to be contacted, or when the transmitter 108 to be contacted can be deformed with little energy consumption during the impact operation, until it comes into contact with the fluidic switching element 6.

The energy transmission is most efficient when the impact occurs centrally and when the effective mass of the parts moved, i.e. essentially of the pusher 8 and of the contact elements 7, is about as large as the mass of the fluidic switching element 6 to be moved.

In FIGS. 3a/b, a further embodiment is depicted which differs from the embodiment in FIGS. 2a/b essentially in that a drive unit comprising two converter elements 12 and two pushers 8 is employed.

A further embodiment of the inventive switching valve 100 relates to a switching valve 100 comprise impact actuation and media separation which may adopt two different switching states 91, 92.

The switching valve 100 which corresponds to the further embodiment consists at least of a valve housing 11 made of suitable materials, e.g. plastic, metal, glass, or ceramics.

The switching valve 100 which corresponds to the further embodiment consists at least of a fluidic housing 5 as part of the valve 100, which consists of at least two parts made of suitable materials, e.g. plastic, metal, glass or ceramics, the parts of the fluidic housing 5 consisting of only one single material or of various materials, and various parts being fluidically interconnected in a sealing manner, and at least part of the fluidic housing 5 forming a fluidic inlet 4, and a further part of the fluidic housing 5 forming a fluidic outlet 3, and at least one transmitter 108 being implemented as part of the fluidic housing 5 or as an elastically deformable area of at least part of the fluidic housing 5, and the fluidic housing 5 containing, within the area filled with fluid, at least two position elements 93, 94 in accordance with the positions 91 and 92 for a fluidic switching element 6.

The switching valve 100 which corresponds to the further embodiment consists at least of one holding element 2, located within that area of the fluidic housing 5 which is filled with fluid, for holding a fluidic switching element 6.

The switching valve 100 which corresponds to the further embodiment consists at least of one fluidic switching element 6 located in that area of the fluidic housing 5 which is filled with fluid, of a suitable material, e.g. polymer material, metal, mineral or ceramics, the fluidic switching element 6, the holding element 2 and the position elements 93, 94 being decisive for the fluidic resistances of the valve 100 in both switching states 91, 92, and the fluidic switching element 6 being located, during the time period of the switching operation of the valve 100, in a different position than one of the positions 91, 92 defined by the position elements 93, 94, and the fluidic switching element 6 being located, outside the time period of the switching operation of the valve 100, in precisely one of the positions 91, 92 defined by the position elements 93, 94, and the potential energy of the fluidic switching element 6 assuming a minimum for each of the positions 91, 92 defined by the position elements 93, 94, and the potential energy of the fluidic switching element 6 being at least larger, in every position other than those 91, 92 defined by the position elements 93, 94, than the minimum potential energy in one of the positions 91, 92.

The switching valve 100 which corresponds to the further embodiment consists at least of one controllable drive unit which is located outside that area of the fluidic housing 5 which is filled with fluid, and which drive unit consists of at least one converter element 12, at least one movable pusher 8, and at least one contact element 7, and optionally either at least one energy store 1 or no energy store 1, the converter element 12 and the pusher 8 being coupled, and either the converter element 12 and the pusher element 8 forming a unit, or the converter element 12 and the pusher element 8 not forming a unit, and either the energy store 1 and the converter element 12 forming a unit or the energy store 1 and the converter element 12 not forming a unit, and the energy store 1 and the pusher element 8 forming a unit or the energy store 1 and the pusher element 8 not forming a unit, and at least one of the contact elements 7 being suitably coupled to the pusher element 8, and each of the contact elements 7, taken by itself, either forming a unit with one of the pushers 8 or forming a unit with none of the pushers 8, and at least the pusher 8 and the contact elements 7 representing a mass, and the pusher 8 being able to move in at least two directions along an axis or in at least two directions in a rotary movement, and the supply of the converter element 12 with energy resulting in that the converter element 12 drives at least the pusher 8 along with at least one of the contact elements 7, this resulting in a movement such that in a first phase of the movement, at least the pusher 8 and at least one of the contact elements 7 receive kinetic energy and that, in a further phase of the movement, the kinetic energy is at least partly transmitted, during an impact operation, to one of the transmitters 108, 109 and to the fluidic switching element 6 by at least one of the contact elements 7, the fluidic switching element 6 moving from a first one 91 of the position defined by the position elements 93, 94 to another one 92 of the position defined by the positions elements 93, 94, or the fluidic switching element 6 remaining in said first position 91.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A switching valve comprising
a fluid housing;
at least one switching element within the fluid housing, the switching element comprising a spherical object;
an actuator outside the fluid housing,
wherein the actuator is configured to cause a pulse-like transmission of force on the switching element by means of an impact-like force effect on the fluid housing, so as to move the switching element from a first position to a second position, the switching element in the first position defining a first fluidic state of a fluid path through the fluid housing, and the switching element in the second position defining a second fluidic state of a fluid path through the fluid housing, which second fluidic state differs from the first fluidic state; and
at least one spring for holding the switching element inside the fluid housing, the at least one spring being configured to stably position the switching element in the first position or in the second position, and the spring being configured to receive an inflow of kinetic energy through the switching element for a change of the switching element from one of the two positions to the other of the two positions.

2. The switching valve as claimed in claim 1, wherein the switching element is configured to stably position itself, while receiving a minimum of the potential energy, in each of the two positions without any further energy consumption, and wherein the switching element is configured to move, while having a breakaway energy supplied to it by the actuator, from one of the two positions to the other of the two positions
wherein the actuator is configured to overcome, by means of the impact-like force effect on the fluid housing, a potential barrier of potential energy which causes the switching element to remain in one of the two positions, as well as further forces preventing the switching element from leaving the respective position, so as to supply the breakaway energy to the switching element.

3. The switching valve as claimed in claim 1, wherein the fluid housing is configured, in the area of the impact-like force effect, as a flexible membrane or as a rigid wall.

4. The switching valve as claimed in claim 1, wherein the actuator comprises:
a converter element; and
a contact element,
the converter element being configured to convert energy from an energy source provided to kinetic energy so as to drive the contact element to cause the impact-like force effect.

5. The switching valve as claimed in claim 4, wherein the actuator further comprises a pusher element for transmitting the kinetic energy, converted by the converter element, to the contact element.

6. The switching valve as claimed in claim 5, wherein the pusher element is clamped at a first end, and is movable at a second end, in the area of which the contact element is mounted.

7. The switching valve as claimed in claim 5, wherein the pusher element comprises a hinge or a bearing, and
wherein the kinetic energy of the converter element is transmitted from a first lever arm, which is formed by a point of a force effect of the converter element on the pusher element and the axis of the bearing or of the hinge, to a second lever arm, which is formed by a point of a force effect of the contact element on the fluid housing and the axis of the bearing or of the hinge.

8. The switching valve as claimed in claim 4, wherein the converter element is configured as a piezoelectric bending converter, as a piezoelectric stack, as an electromagnetic drive, as an electrostatic drive, as a pneumatic drive, as a hydraulic drive, or as a manual drive with mechanical transmission.

9. The switching valve as claimed in claim 7, wherein the actuator comprises an energy store which is charged with the breakaway energy by the converter element, and gives off the breakaway energy to the contact element.

10. The switching valve as claimed in claim 1, wherein the fluid housing comprises a sealing element configured to seal off the passage of the fluid through the fluid housing together with the switching element located in the second position, so as to close the switching valve.

11. The switching valve as claimed in claim 1, wherein the fluid housing is configured to unblock, with a switching element in the first position, a first fluid path through the fluid housing, and to block a second fluid path through the fluid housing, which second fluid path differs from the first fluid path, and wherein the fluid housing is configured to unblock, with a switching element in the second position, the second fluid path through the fluid housing and to block the first fluid path through the fluid housing.

12. The switching valve as claimed in claim 1, wherein the switching element is configured to adopt the second position upon a failure in the energy supply, so as to comprise as large a fluidic resistance as possible.

13. The switching valve as claimed in claim 1, wherein the actuator is configured to cause the impact-like force effect on the fluid housing at a plurality of external housing points so as to move the switching element from the first or second position to a further position, the location of which is determined from a superposition of the forces acting upon the switching element at the plurality of external housing points,
wherein the switching valve comprises a plurality of switching states determined by the positions adopted by the at least one switching element, and wherein each of the switching states comprises at least one fluid path through the fluid housing associated with it.

14. The switching valve as claimed in claim 13, wherein the actuator further comprises a programmable control so as to cause, in dependence on a control signal, the force effect on the fluid housing at external housing points among the plurality of external housing points, so that the at least one switching element adopts the position predefined by the control.

15. A method for switching a switching valve, comprising
a fluid housing;
at least one switching element within the fluid housing, the switching element comprising a spherical object;
an actuator outside the fluid housing; and
at least one spring for holding the switching element inside the fluid housing, the at least one spring being configured to stably position the switching element in the first position or in the second position, and the spring being configured to receive an inflow of kinetic energy through the switching element for a change of the switching element from one of the two positions to the other of the two positions,
the method comprising:
applying an impact-like force effect on the fluid housing with the actuator so as to cause pulse-like force transmission to the switching element so as to move the switching element from a first position to a second position, the switching element in the first position defining a first fluidic state of a fluid path through the fluid housing, and the switching element in the second position defining a second fluidic state of a fluid path through the fluid housing, which second fluidic state differs from the first fluidic state.
